(19) United States
(12) Patent Application Publication
(10) Pub. No.: US 2004/0075345 A1
(43) Pub. Date: Apr. 22, 2004

(54) On-vehicle radio-communication terminal apparatus and emergency reporting network system

(76) Inventors: Kenji Yoshioka, Yokohama-shi (JP); Osamu Miyawaki, Yokohama-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/640,612

(22) Filed: Aug. 14, 2003

Related U.S. Application Data
(63) Continuation of application No. 09/546,581, filed on Apr. 11, 2000, now abandoned.

(30) Foreign Application Priority Data
May 26, 1999 (JP) 11-146963
May 10, 1999 (JP) 11-128408
May 10, 1999 (JP) 11-128407

(51) Int. Cl. H02J 7/00

(52) U.S. Cl. 307/66

(57) ABSTRACT

An on-vehicle radio-communication terminal apparatus uses a main battery as a power supply, and receives electric power from the power supply. A decision is made as to whether or not a voltage of the electric power from the power supply drops below a predetermined reference level. When it is decided that the voltage of the electric power from the power supply drops below the predetermined reference level, an auxiliary battery is used as at least part of the power supply.

### BACKGROUND OF THE INVENTION

1. Field of the Invention

This invention relates to an on-vehicle radio-communication terminal apparatus. Also, this invention relates to an emergency reporting network system for vehicles such as automotive vehicles.

In addition, this invention relates to a terminal apparatus used in an emergency reporting network system.

2. Description of the Related Art

On-vehicle radio-communication terminal apparatuses are fed with electric power only from batteries respectively. Therefore, operation of such an on-vehicle apparatus is suspended when the power supply from a battery stops. It is desirable to maintain operation of the on-vehicle apparatus even when the power supply from the battery stops.

### SUMMARY OF THE INVENTION

It is a first object of this invention to provide an improved on-vehicle radio-communication terminal apparatus.

It is a second object of this invention to provide an improved emergency reporting network system for vehicles such as automotive vehicles.

It is a third object of this invention to provide an improved terminal apparatus used in an emergency reporting network system.

A first aspect of this invention provides an on-vehicle radio-communication terminal apparatus comprising first means for using a main battery as a power supply and for receiving electric power from the power supply; an auxiliary battery; second means for deciding whether or not a voltage of the electric power from the power supply drops below a predetermined reference level; and third means for using the auxiliary battery as at least part of the power supply when the second means decides that the voltage of the electric power from the power supply drops below the predetermined reference level.

A second aspect of this invention is based on the first aspect thereof, and provides an on-vehicle radio-communication terminal apparatus wherein the second means comprises an analog-to-digital converter for changing the voltage of the electric power into a corresponding digital signal, and means for comparing the digital signal with data representing the predetermined reference level.

A third aspect of this invention is based on the first aspect thereof, and provides an on-vehicle radio-communication terminal apparatus wherein the second means comprises a comparator for comparing the voltage of the electric power with the predetermined reference level.

A fourth aspect of this invention is based on the first aspect thereof, and provides an on-vehicle radio-communication terminal apparatus further comprising fourth means for repetitively enabling the second means to execute the deciding on an interruption basis.

A fifth aspect of this invention is based on the first aspect thereof, and provides an on-vehicle radio-communication terminal apparatus wherein the predetermined reference level is higher than a minimum level necessary for operation.

A sixth aspect of this invention is based on the first aspect thereof, and provides an on-vehicle radio-communication terminal apparatus wherein the second means comprises a voltage divider for dividing the voltage of the electric power by a predetermined value and generating a signal representative of a result of the dividing, an analog-to-digital converter for changing the dividing-result signal into a corresponding digital signal, and means for comparing the digital signal with data corresponding to the predetermined reference level.

A seventh aspect of this invention is based on the first aspect thereof, and provides an on-vehicle radio-communication terminal apparatus further comprising fourth means for deciding whether or not the voltage of the electric power from the power supply rises above a predetermined criterion level, and fifth means for stopping the third means from using the auxiliary battery as at least part of the power supply when the fourth means decides that the voltage of the electric power from the power supply rises above the predetermined criterion level.

An eighth aspect of this invention is based on the seventh aspect thereof, and provides an on-vehicle radio-communication terminal apparatus wherein the predetermined criterion level is higher than the predetermined reference level.

A ninth aspect of this invention provides an emergency reporting apparatus including the on-vehicle radio-communication terminal apparatus of one of the first to the eighth aspects of this invention.

A tenth aspect of this invention provides an emergency reporting network system comprising an emergency report receiving center; a communication network; and emergency reporting apparatuses connectable with the emergency report receiving center via the communication network; wherein each of the emergency reporting apparatuses comprises the emergency reporting apparatus of the ninth aspect of this invention.

An eleventh aspect of this invention provides an emergency reporting apparatus for a vehicle having a sensor detecting a speed of a body of the vehicle. The apparatus comprises first means for using a main battery as a power supply and for receiving electric power from the power supply; an auxiliary battery; second means for using the auxiliary battery as at least part of the power supply; third means for deciding whether or not the detected vehicle speed exceeds a predetermined reference speed; and fourth means for permitting the second means to use the auxiliary battery as at least part of the power supply when the third means decides that the detected vehicle speed exceeds the predetermined reference speed.

A twelfth aspect of this invention is based on the eleventh aspect thereof, and provides an emergency reporting apparatus further comprising fifth means for inhibiting the second means from using the auxiliary battery as at least part of the power supply when the third means decides that the detected vehicle speed does not exceed the predetermined reference speed.

A thirteenth aspect of this invention is based on the eleventh aspect thereof, and provides an emergency reporting apparatus further comprising fifth means for deciding whether or not a vehicle accessory changes from its on state to its off state, sixth means for inhibiting the second means from using the auxiliary battery as at least part of the power supply when the fifth means decides that the vehicle accessory changes from its on state to its off state, seventh means for deciding whether or not a vehicle engine ignition system changes from its on state to its off state, and eighth means for inhibiting the second means from using the auxiliary battery as at least part of the power supply when the seventh means decides that the vehicle engine ignition system changes from its on state to its off state.

A fourteenth aspect of this invention provides an emergency reporting apparatus for a vehicle having an accessory, an engine ignition, and a sensor detecting a speed of a body of the vehicle. The apparatus comprises first means for using a main battery as a power supply and for receiving electric power from the power supply; an auxiliary battery; second means for using the auxiliary battery as at least part of the power supply; third means for deciding whether or not the detected vehicle speed exceeds a predetermined reference speed; fourth means for deciding whether or not a time elapsed since a moment at which the vehicle accessory changes from its off state to its on state reaches a predetermined reference time; fifth means for deciding whether or not a time elapsed since a moment at which the vehicle engine ignition changes from its off state to its on state reaches a preset reference time; and sixth means for permitting the second means to use the auxiliary battery as at least part of the power supply in at least one of 1) a first case where the third means decides that the detected vehicle speed exceeds the predetermined reference speed, 2) a second case where the fourth means decides that the elapsed time reaches the predetermined reference time, and 3) a third case where the fifth means decides that the elapsed time reaches the preset reference time.

A fifteenth aspect of this invention provides an emergency reporting network system comprising an emergency report receiving center; a communication network; and emergency reporting apparatuses connectable with the emergency report receiving center via the communication network; wherein each of the emergency reporting apparatuses comprises the emergency reporting apparatus of one of the eleventh to fourteenth aspects of this invention.

A sixteenth aspect of this invention provides an emergency reporting apparatus comprising first means for using a main battery as a power supply and for receiving electric power from the power supply; an auxiliary battery; second means for deciding whether or not a voltage of the electric power from the power supply drops below a predetermined reference level; third means for using the auxiliary battery as at least part of the power supply when the second means decides that the voltage of the electric power from the power supply drops below the predetermined reference level; fourth means for measuring a length of a time during which the third means continues to use the auxiliary battery as at least part of the power supply, and for generating a first signal representing the measured time length; fifth means for measuring a number of times the third means uses the auxiliary battery as at least part of the power supply, and for generating a second signal representing the measured number of times; and sixth means for storing the first signal generated by the fourth means and the second signal generated by the fifth means.

A seventeenth aspect of this invention is based on the sixteenth aspect thereof, and provides an emergency reporting apparatus further comprising seventh means for calculating a sum of time lengths measured by the fourth means, and for generating a third signal representing the calculated sum, and eighth means for storing the third signal generated by the seventh means.

An eighteenth aspect of this invention is based on the seventeenth aspect thereof, and provides an emergency reporting apparatus further comprising seventh means for initializing the first signal, the second signal, and the third signal when the auxiliary battery is replaced by a new one.

A nineteenth aspect of this invention is based on the sixteenth aspect thereof, and provides an emergency reporting apparatus wherein the sixth means comprises a nonvolatile memory.

A twentieth aspect of this invention is based on the seventeenth aspect thereof, and provides an emergency reporting apparatus further comprising seventh means for informing a user of contents of the first signal, the second signal, and the third signal.

A twenty-first aspect of this invention is based on the seventeenth aspect thereof, and provides an emergency reporting apparatus further comprising seventh means for outputting the first signal, the second signal, and the third signal to an external device.

A twenty-second aspect of this invention is based on the sixteenth aspect thereof, and provides an emergency reporting apparatus further comprising seventh means for deciding whether or not the time length measured by the fourth means exceeds a predetermined reference length, eighth means for informing when the seventh means decides that the time length measured by the fourth means exceeds the predetermined reference length, ninth means for deciding whether or not the number of times which is measured by the fifth means exceeds a predetermined reference number of times, and tenth means for informing when the ninth means decides that the number of times which is measured by the fifth means exceeds the predetermined reference number of times.

A twenty-third aspect of this invention provides an emergency reporting network system comprising an emergency report receiving center; a communication network; and emergency reporting apparatuses connectable with the emergency report receiving center via the communication network; wherein each of the emergency reporting apparatuses comprises the emergency reporting apparatus of one of the sixteenth to twenty-second aspects of this invention.

### BRIEF DESCRIPTION OF THE DRAWINGS

FIG. 1 is a block diagram of a terminal apparatus according to a first embodiment of this invention.

FIG. 2 is a flowchart of a segment of a program for a controller in FIG. 1.

FIG. 3 is a time-domain diagram of a voltage at a power feed line in the terminal apparatus of FIG. 1.

FIG. 4 is a block diagram of a terminal apparatus according to a second embodiment of this invention.

FIG. 5 is a schematic diagram of a voltage divider in FIG. 4.

FIG. 6 is a flowchart of a segment of a program for a controller in FIG. 4.

FIG. 7 is a block diagram of an emergency reporting apparatus according to a third embodiment of this invention.

FIG. 8 is a block diagram of an emergency reporting apparatus according to a fourth embodiment of this invention.

FIG. 9 is a flowchart of a segment of a program for a controller in FIG. 8.

FIG. 10 is a block diagram of an emergency reporting apparatus according to a fifth embodiment of this invention.

FIG. 11 is a block diagram of an emergency reporting apparatus according to a sixth embodiment of this invention.

FIG. 12 is a block diagram of an emergency reporting apparatus according to a seventh embodiment of this invention.

FIG. 13 is a flowchart of a segment of a program for a controller in FIG. 12.

FIG. 14 is a block diagram of an emergency reporting apparatus according to an eighth embodiment of this invention.

FIG. 15 is a block diagram of an emergency reporting apparatus according to a ninth embodiment of this invention.

FIG. 16 is a block diagram of an emergency reporting apparatus according to a tenth embodiment of this invention.

### DESCRIPTION OF THE PREFERRED EMBODIMENTS

### First Embodiment

A vehicle management network system includes terminal apparatuses which are mounted on vehicles (for example, automotive vehicles) respectively. The vehicle management network system also includes a vehicle management center which operates as a host apparatus. The terminal apparatuses can be connected with the host apparatus (the vehicle management center) via a mobile telephone network. The vehicle management center governs the vehicles through communications with the terminal apparatuses.

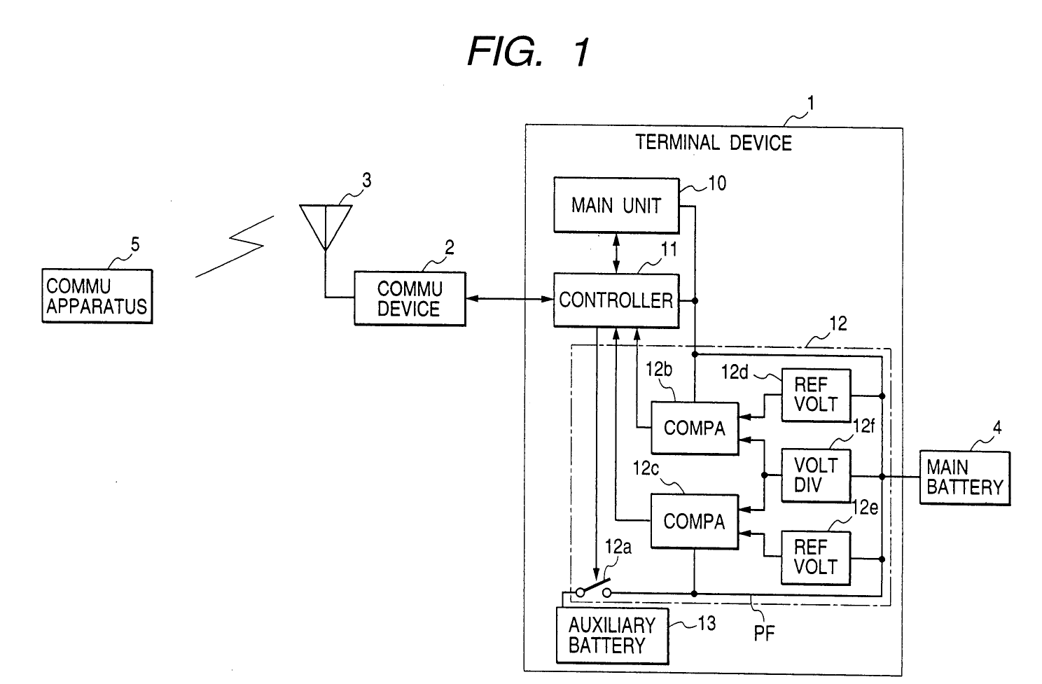

FIG. 1 shows a terminal apparatus according to a first embodiment of this invention. The terminal apparatus is mounted on a vehicle such as an automotive vehicle. Thus, the terminal apparatus is also referred to as the on-vehicle terminal apparatus.

As shown in FIG. 1, the terminal apparatus includes a terminal device 1, a radio communication device 2, and a communication antenna 3. The terminal device 1 is connected to the radio communication device 2. The radio communication device 2 may be provided in the terminal device 1. The communication antenna 3 is connected to the radio communication device 2. A main battery 4 is connected to the terminal device 1. Normally, the terminal device 1 is powered by the main battery 4 only. The main battery 4 may be a vehicle battery.

The radio communication device 2 is a portion of a portable telephone set or a mobile telephone set. The radio communication device 2 is controlled by the terminal device 1. The radio communication device 2 can output and feed a radio signal to the communication antenna 3. The radio signal is radiated by the communication antenna 3. The radiated radio signal can propagate to a base station of a related radio telephone network. The communication antenna 3 can receive a radio signal from the base station. The received radio signal is fed from the communication antenna 3 to the radio communication device 2. In this way, the radio communication device 2 can communicate with the base station by radio on a two-way basis.

The radio communication device 2 can receive a call requirement signal and a destination-telephone-number signal from the terminal device 1. Upon the reception of the call requirement signal, the radio communication device 2 generates a radio signal to call the communication opposite party designated by the destination telephone number. The communication opposite party is, for example, a vehicle management center. The radio call signal contains a dial signal. The radio call signal is fed from the radio communication device 2 to the communication antenna 3 before being radiated thereby. The radio call signal propagates to a base station. The corresponding call signal is transmitted via the base station to a communication apparatus 5 in the communication opposite party designated by the destination telephone number. Normally, an answer signal responsive to the call signal is transmitted from the communication apparatus 5 in the communication opposite party to the base station. The corresponding radio answer signal is transmitted from the base station. The communication antenna 3 receives the radio answer signal. The received radio answer signal is fed from the communication antenna 3 to the radio communication device 2. The radio communication device 2 recognizes from the radio answer signal that connection with the communication opposite party is established. Then, the radio communication device 2 changes to a data communication mode of operation or a speech communication mode of operation. In addition, the radio communication device 2 informs the terminal device 1 that the connection with the communication opposite party is established.

The radio communication device 2 can receive, from the terminal device 1, positional information data representing the position of the related vehicle, the direction of travel of the related vehicle, and the orientation of the related vehicle. During the data communication mode of operation, the radio communication device 2 transmits the positional information data to the communication opposite party via the base station. As previously mentioned, the communication opposite party is, for example, a vehicle management center. During the speech communication mode of operation, the radio communication device 2 allows two-way speech communications between a user (a driver or an occupant of the related vehicle) and an operator of the communication opposite party via the base station.

As shown in FIG. 1, the terminal device 1 includes a main unit 10, a controller 11, a power supply control circuit 12, and an auxiliary battery 13. The main unit 10 is connected to the controller 11 and the power supply control circuit 12. The controller 11 is connected to the power supply control circuit 12. The controller 11 is also connected to the radio communication device 2. The power supply control circuit 12 is connected to the auxiliary battery 13. The power supply control circuit 12 is also connected to the main battery 4.

The controller 11 includes a microcomputer, a CPU, or a similar device having a combination of an input/output port, a signal processing section, a RAM, and a ROM. The controller 11 operates in accordance with a program stored in the ROM. According to the program, the controller 11 controls the radio communication device 2, the main unit 10, and the power supply control circuit 12.

The controller 11 can transmit and receive signals and data to and from the radio communication device 2. The controller 11 can transmit and receive signals and data to and from the main unit 10. Specifically, the controller 11 can receive data representative of a destination telephone number from a memory within the main unit 10. The controller 11 can output a destination-telephone-number signal to the radio communication device 2. In addition, the controller 11 can output a call requirement signal to the radio communication device 2. The controller 11 can receive, from the radio communication device 2, a signal representing that the connection with a communication opposite party is established. The controller 11 can receive positional information data from the main unit 10. The controller 11 can output the positional information data to the radio communication device 2. As previously mentioned, the positional information data represent the position of the related vehicle, the direction of travel of the related vehicle, and the orientation of the related vehicle. The controller 11 can transmit speech signals between the radio communication device 2 and the main unit 10.

As shown in FIG. 1, the power supply control circuit 12 includes a switch 12a, comparators 12b and 12c, constant-voltage generators 12d and 12e, and a voltage divider 12f.

The switch 12a selectively connects and disconnects the auxiliary battery 13 to and from a power feed line PF in response to a control signal fed from the controller 11. Normally, the switch 12a disconnects the auxiliary battery 13 from the power feed line PF. Thus, the switch 12a is of a normally open type. The auxiliary battery 13 is provided with a back-current blocking diode at the connection with the switch 12a. The power feed line PF leads from the main battery 4. The voltage divider 12f is connected to the power feed line PF. The main battery 4 is provided with a back-current blocking diode at the connection with the power feed line PF. The voltage divider 12f divides the voltage at the power feed line PF (the +B voltage) by a given value. The voltage divider 12f outputs the division-resultant voltage to the comparators 12b and 12c. The constant-voltage generator 12d produces a first predetermined voltage. The constant-voltage generator 12d outputs the first predetermined voltage to the comparator 12b. The constant-voltage generator 12e produces a second predetermined voltage. The constant-voltage generator 12e outputs the second predetermined voltage to the comparator 12c.

The device 12b compares the output voltage from the voltage divider 12f with the first predetermined voltage. The first predetermined voltage is chosen to correspond to a first reference voltage with respect to the voltage at the power feed line PF (the +B voltage). Thus, operation of the comparator 12b is equivalent to comparison between the +B voltage with the first reference voltage. The first reference voltage is chosen to be higher than the minimum voltage necessary for normal operation of the devices 10, 11, 12b, 12c, 12d, and 12e. The comparator 12b generates a comparison-result signal which depends on whether the +B voltage drops below the first reference voltage. The comparator 12b outputs the comparison-result signal to the controller 11.

The device 12c compares the output voltage from the voltage divider 12f with the second predetermined voltage. The second predetermined voltage is chosen to correspond to a second reference voltage with respect to the voltage at the power feed line PF (the +B voltage). The second reference voltage is higher than the first reference voltage. Operation of the comparator 12c is equivalent to comparison between the +B voltage with the second reference voltage. The comparator 12c generates a comparison-result signal which depends on whether the +B voltage rises above the second reference voltage. The comparator 12c outputs the comparison-result signal to the controller 11.

The power feed line PF is connected to the main unit 10, the controller 11, the comparators 12b and 12c, and the constant-voltage generators 12d and 12e. In the case where the switch 12a disconnects the auxiliary battery 13 from the power feed line PF, electric power is fed only from the main battery 4 to the devices 10, 11, 12b, 12c, 12d, and 12e. Thus, in this case, the devices 10, 11, 12b, 12c, 12d, and 12e are activated by the electric power fed from the main battery 4 only. On the other hand, in the case where the switch 12a connects the auxiliary battery 13 to the power feed line PF, electric power is fed from both the main battery 4 and the auxiliary battery 13 to the devices 10, 11, 12b, 12c, 12d, and 12e. Thus, in this case, the devices 10, 11, 12b, 12c, 12d, and 12e are activated by the electric power fed from both the main battery 4 and the auxiliary battery 13.

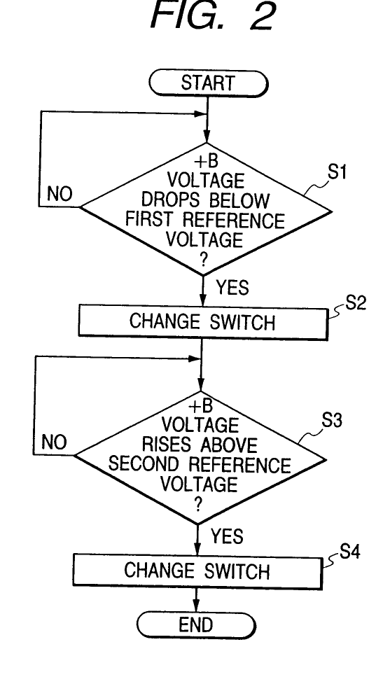

FIG. 2 is a flowchart of a segment of the program for the controller 11. The program segment in FIG. 2 may be periodically executed on a timer-based interruption basis.

As shown in FIG. 2, a first step S1 of the program segment decides whether or not the +B voltage (the voltage at the power feed line PF) drops below the first reference voltage by referring to the output signal from the comparator 12b. When the +B voltage drops below the first reference voltage, the program advances from the step S1 to a step S2. Otherwise, the step S1 is repeated.

The step S2 changes or closes the switch 12a to connect the auxiliary battery 13 to the power feed line PF. Therefore, the main battery 4 is helped by the auxiliary battery 13, and the devices 10, 11, 12b, 12c, 12d, and 12e are now activated by the electric power fed from both the main battery 4 and the auxiliary battery 13. Thus, the devices 10, 11, 12b, 12c, 12d, and 12e remain sufficiently powered even when the +B voltage drops below the first reference voltage. After the step S2, the program advances to a step S3.

The step S3 decides whether or not the +B voltage (the voltage at the power feed line PF) rises above the second reference voltage by referring to the output signal from the comparator 12c. When the +B voltage rises above the second reference voltage, the program advances from the step S3 to a step S4. Otherwise, the step S3 is repeated.

The step S4 changes or opens the switch 12a to disconnect the auxiliary battery 13 from the power feed line PF. Therefore, the devices 10, 11, 12b, 12c, 12d, and 12e are now activated by the electric power fed from the main battery 4 only. After the step S4, the current execution cycle of the program segment ends.

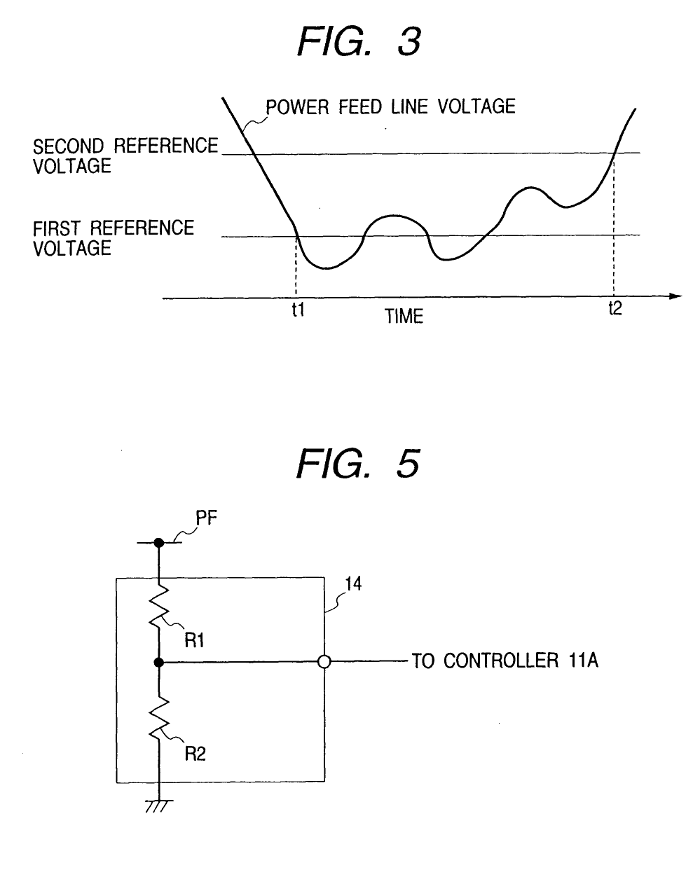

FIG. 3 shows an example of a time-domain variation in the voltage at the power feed line PF (the +B voltage). With reference to FIG. 3, at a moment t1, the voltage at the power feed line PF drops below the first reference voltage. Therefore, at the moment t1, the switch 12a is closed so that the auxiliary battery 13 is connected to the power feed line PF. Thus, the main battery 4 is helped by the auxiliary battery 13, and the devices 10, 11, 12b, 12c, 12d, and 12e are now activated by the electric power fed from both the main battery 4 and the auxiliary battery 13. As previously mentioned, the first reference voltage is chosen to be higher than the minimum voltage necessary for normal operation of the devices 10, 11, 12b, 12c, 12d, and 12e. At a moment t2 which follows the moment t1, the voltage at the power feed line PF rises above the second reference voltage. Therefore, at the moment t2, the switch 12a is opened so that the auxiliary battery 13 is disconnected from the power feed line PF. Thus, the devices 10, 11, 12b, 12c, 12d, and 12e are now activated by the electric power fed from the main battery 4 only.

It should be noted that the main battery 4 may be replaced by the auxiliary battery 13 when the voltage of the main battery 4 drops below a first threshold level. In this case, the auxiliary battery 13 is replaced by the main battery 4 when the voltage of the main battery 4 rises above a second threshold level higher than the first threshold level.

### Second Embodiment

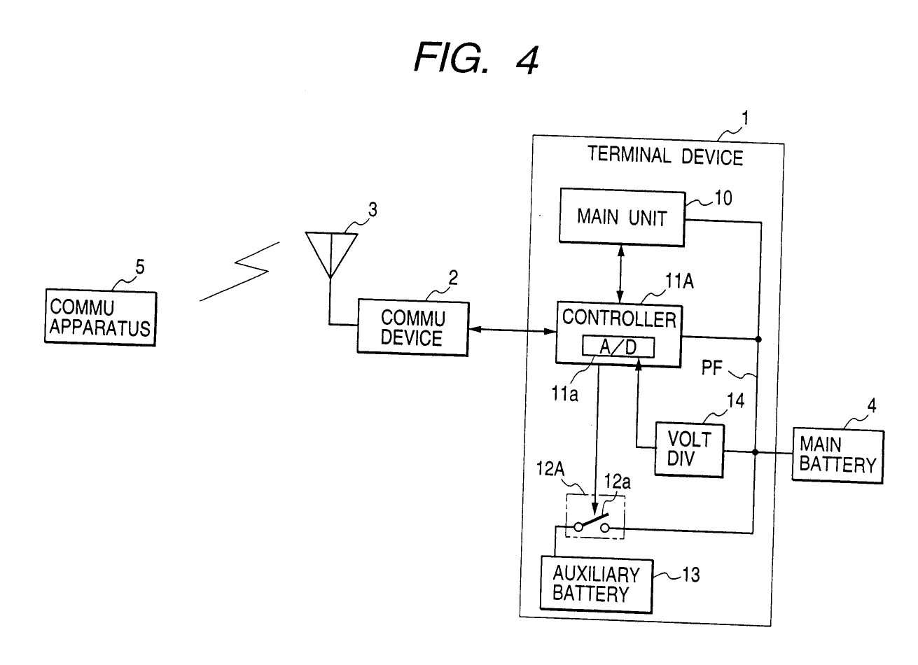

FIG. 4 shows a terminal apparatus according to a second embodiment of this invention. The terminal apparatus in FIG. 4 is similar to the terminal apparatus in FIG. 1 except for design changes mentioned hereinafter. The terminal apparatus in FIG. 4 includes a terminal device 1A which replaces the terminal device 1 (see FIG. 1). The terminal device 1A includes a controller 11A and a power supply control circuit 12A instead of the controller 11 and the power supply control circuit 12 (see FIG. 1) respectively. The terminal device 1A includes a voltage divider 14 connected between a main battery 4 and the controller 11A. The controller 11A includes an input/output port provided with an analog-to-digital (A/D) converter 11a connected to the voltage divider 14.

The voltage divider 14 divides a voltage at a power feed line PF (a +B voltage) by a given value. The voltage divider 14 outputs the division-resultant voltage to the A/D converter 11a within the controller 11A. The A/D converter 11a changes the output voltage from the voltage divider 14 into a corresponding digital signal which represents the voltage at the power feed line PF (the +B voltage).

A switch 12a within the power supply control circuit 12A selectively connects and disconnects an auxiliary battery 13 to the power feed line PF in response to a control signal fed from the controller 11A. Normally, the switch 12a disconnects the auxiliary battery 13 from the power feed line PF. Thus, the switch 12a is of a normally open type. The controller 11A and a main unit 10 are connected to the power feed line PF. In the case where the switch 12a disconnects the auxiliary battery 13 from the power feed line PF, electric power is fed only from the main battery 4 to the devices 10 and 11A. Thus, in this case, the devices 10 and 11A are activated by the electric power fed from the main battery 4 only. On the other hand, in the case where the switch 12a connects the auxiliary battery 13 to the power feed line PF, electric power is fed from both the main battery 4 and the auxiliary battery 13 to the devices 10 and 11A. Thus, in this case, the devices 10 and 11A are activated by the electric power fed from both the main battery 4 and the auxiliary battery 13.

As shown in FIG. 5, the voltage divider 14 includes fixed resistors R1 and R2 connected in series. The series combination of the resistors R1 and R2 is connected between the power feed line PF and the ground. The junction between the resistors R1 and R2 is connected to the A/D converter 11a within the controller 11A. The resistors R1 and R2 cooperate to divide the voltage at the power feed line PF (the +B voltage) by a given value determined by the resistances of the resistors R1 and R2. The division-resultant voltage which appears at the junction between the resistors R1 and R2 is applied to the A/D converter 11a.

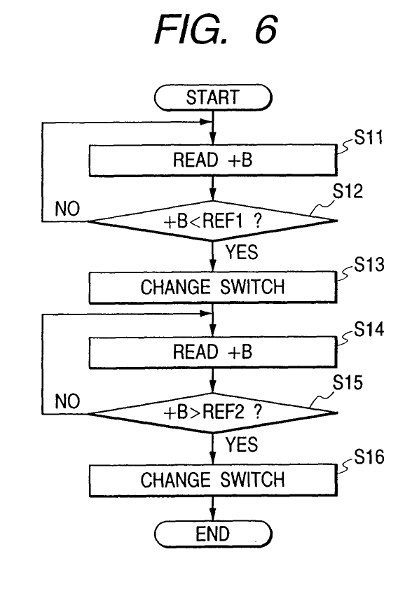

FIG. 6 is a flowchart of a segment of a program for the controller 11A. The program segment in FIG. 6 may be periodically executed on a timer-based interruption basis.

As shown in FIG. 6, a first step S11 of the program segment detects the present +B voltage (the present voltage at the power feed line PF) by referring to an output signal of the A/D converter 11a.

A step S12 following the step S11 decides whether or not the present +B voltage drops below a first reference voltage. The first reference voltage is preset to be higher than the minimum voltage necessary for normal operation of the devices 10 and 11A. When the present +B voltage drops below the first reference voltage, the program advances from the step S12 to a step S13. Otherwise, the program returns from the step S12 to the step S11.

The step S13 changes or closes the switch 12a to connect the auxiliary battery 13 to the power feed line PF. Therefore, the main battery 4 is helped by the auxiliary battery 13, and the devices 10 and 11A are now activated by the electric power fed from both the main battery 4 and the auxiliary battery 13. Thus, the devices 10 and 11A remain sufficiently powered even when the +B voltage drops below the first reference voltage. After the step S13, the program advances to a step S14.

The step S14 detects the present +B voltage by referring to the output signal of the A/D converter 11a. A step S15 following the step S14 decides whether or not the present +B voltage rises above a second reference voltage. The second reference voltage is preset to be higher than the first reference voltage. When the +B voltage rises above the second reference voltage, the program advances from the step S15 to a step S16. Otherwise, the program returns from the step S15 to the step S14.

The step S16 changes or opens the switch 12a to disconnect the auxiliary battery 13 from the power feed line PF. Therefore, the devices 10 and 11A are now activated by the electric power fed from the main battery 4 only. After the step S16, the current execution cycle of the program segment ends.

It should be noted that the main battery 4 may be replaced by the auxiliary battery 13 when the voltage of the main battery 4 drops below a first threshold level. In this case, the auxiliary battery 13 is replaced by the main battery 4 when the voltage of the main battery 4 rises above a second threshold level higher than the first threshold level.

### Third Embodiment

An emergency reporting network system includes emergency reporting apparatuses which are mounted on vehicles (for example, automotive vehicles) respectively. The emergency reporting apparatuses are terminal apparatuses. The emergency reporting network system also includes an emergency report receiving center which operates as a host apparatus. The emergency report receiving center is, for example, a police station or a fire station. The emergency reporting apparatuses can be connected with the host apparatus (the emergency report receiving center) via a mobile telephone network.

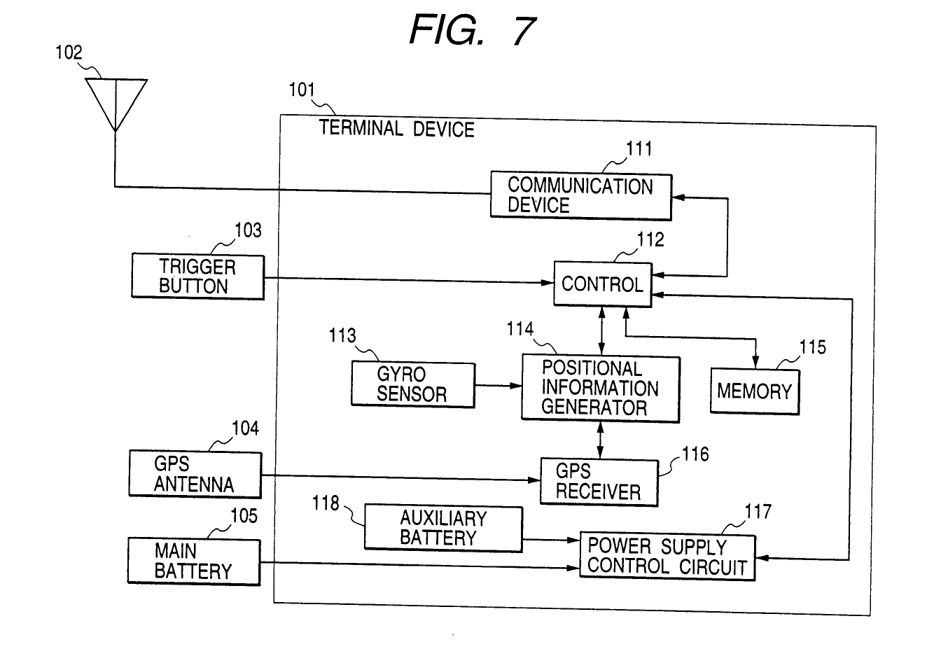

FIG. 7 shows an emergency reporting apparatus (a terminal apparatus) according to a third embodiment of this invention. The emergency reporting apparatus is mounted on a vehicle such as an automotive vehicle.

As shown in FIG. 7, the emergency reporting apparatus includes a terminal device 101, a communication antenna 102, a trigger button 103, and a GPS (Global Positioning System) antenna 104. The terminal device 101 is connected to the communication antenna 102, the trigger button 103, and the GPS antenna 104. In addition, the terminal device 101 is connected to a main battery 105. The main battery 105 may be a vehicle battery.

The terminal device 101 includes a communication device 111, a controller 112, a gyro sensor 113, a positional information generator 114, a memory 115, a GPS receiver 116, a power supply control circuit 117, and an auxiliary battery 118. The communication device 111 is connected to the communication antenna 102 and the controller 112. The controller 112 is connected to the trigger button 103, the positional information generator 114, the memory 115, and the power supply control circuit 117. The gyro sensor 113 is connected to the positional information generator 114. The GPS receiver 116 is connected to the GPS antenna 104 and the positional information generator 114. The power supply control circuit 117 is connected to the main battery 105 and the auxiliary battery 118.

The trigger button 103 includes a manually-operated button which can be accessed by a user, that is, a driver or an occupant of the related vehicle. When the trigger button 103 is depressed, a trigger signal is transmitted from the trigger button 103 to the controller 112 as an emergency-occurrence indicating signal.

The GPS antenna 104 can receive GPS signals from GPS satellites. The GPS antenna 104 feeds the received GPS signals to the GPS receiver 116.

The communication device 111 includes a telephone set such as a mobile telephone set having a radio communication device which can be controlled by the controller 112. The communication device 111 can output and feed a radio signal to the communication antenna 102. The radio signal is radiated by the communication antenna 102. The radiated radio signal can propagate to a base station of a related radio telephone network. The communication antenna 102 can receive a radio signal from the base station. The received radio signal is fed from the communication antenna 102 to the communication device 111. In this way, the communication device 111 can communicate with the base station by radio on a two-way basis.

The communication device 111 can receive a call requirement signal and a destination-telephone-number signal from the controller 112. Upon the reception of the call requirement signal, the communication device 111 generates a radio signal to call the communication opposite party designated by the destination telephone number. The communication opposite party is, for example, an emergency report receiving center (a police station or a fire station). The radio call signal contains a dial signal. The radio call signal is fed from the communication device 111 to the communication antenna 102 before being radiated thereby. The radio call signal propagates to a base station. The corresponding call signal is transmitted via the base station to the communication opposite party designated by the destination telephone number. Normally, an answer signal responsive to the call signal is transmitted from the communication opposite party to the base station. The corresponding radio answer signal is transmitted from the base station. The communication antenna 102 receives the radio answer signal. The received radio answer signal is fed from the communication antenna 102 to the communication device 111. The communication device 111 recognizes from the radio answer signal that connection with the communication opposite party is established. Then, the communication device 111 changes to a data communication mode of operation or a speech communication mode of operation. In addition, the communication device 111 informs the controller 112 that the connection with the communication opposite party is established.

The communication device 111 can receive, from the controller 112, positional information data representing the position of the related vehicle, the direction of travel of the related vehicle, and the orientation of the related vehicle. During the data communication mode of operation, the communication device 111 transmits the positional information data to the communication opposite party via the base station. As previously mentioned, the communication opposite party is, for example, an emergency report receiving center (a police station or a fire station). During the speech communication mode of operation, the communication device 111 allows two-way speech communications between a user (a driver or an occupant of the related vehicle) and an operator of the communication opposite party via the base station.

The controller 112 includes a microcomputer, a CPU, or a similar device having a combination of an input/output port, a signal processing section, a RAM, and a ROM. The controller 112 operates in accordance with a program stored in the ROM.

The gyro sensor 113 generates data representing the direction of travel of the related vehicle and the orientation of the related vehicle. The gyro sensor 113 outputs the generated data to the positional information generator 114. The GPS receiver 116 generates data representative of the position of the related vehicle in response to the GPS signals fed from the GPS antenna 104. The GPS receiver 116 outputs the generated data to the positional information generator 114. The positional information generator 114 produces positional information data in response to the output data from the gyro sensor 113 and the output data from the GPS receiver 116. The produced positional information data represent the position of the related vehicle, the direction of travel of the related vehicle, and the orientation of the related vehicle. The positional information generator 114 can output the produced positional information data to the controller 112.

The memory 115 stores information representing the telephone number of an emergency report receiving center (a police station or a fire station), the registration number of the related vehicle, and the registration number (for example, the identification number) of the user. The memory 115 can be accessed by the controller 112. The positional information data and the present time data are periodically written into the memory 115 by the controller 112 so that data representing a history of the position of the related vehicle are accumulated in the memory 115.

Normally, the power supply control circuit 117 feeds power only from the main battery 105 to the units 111, 112, 113, 114, 115, and 116 within the terminal device 101. The power supply control circuit 117 includes a first section for detecting the voltage of fed power (the +B voltage), and a second section for comparing the detected voltage of fed power with a predetermined reference level. The reference level is preset to be higher than the minimum voltage necessary for normal operation of the units 111, 112, 113, 114, 115, and 116. In addition, the power supply control circuit 117 includes a third section for feeding power from both the main battery 105 and the auxiliary battery 118 to the units 111, 112, 113, 114, 115, and 116. When the voltage of fed power drops below the reference level, the power supply control circuit 117 outputs a signal representative of the voltage drop to the controller 112. The controller 112 outputs a control signal to the power supply control circuit 117 in response to the voltage-drop signal. The control signal is designed so that the power supply control circuit 117 uses both the main battery 105 and the auxiliary battery 118 as power sources for the units 111, 112, 113, 114, 115, and 116, and hence enables the auxiliary battery 118 to help the main battery 105. At the same time, the power supply control circuit 117 informs the controller 112 that the main battery 105 is helped by the auxiliary battery 118. Thus, the units 111, 112, 113, 114, 115, and 116 remain sufficiently powered even when the voltage of fed power drops below the reference level.

The emergency reporting apparatus in FIG. 7 operates as follows. The positional information generator 114 produces positional information data in response to the output data from the gyro sensor 113 and the output data from the GPS receiver 116. The controller 112 periodically receives the positional information data from the positional information generator 114, and periodically writes the positional information data into the memory 115 together with the present time data. Accordingly, data representing a history of the position of the related vehicle are accumulated in the memory 115.

In the event of an emergency such as an accident or a sudden illness, the trigger button 103 can be depressed by a user (a driver or an occupant of the related vehicle). The depression of the trigger button 103 sends an emergency-occurrence indicating signal to the controller 112. The controller 112 recognizes from the emergency-occurrence indicating signal that an emergency occurs and the emergency should be reported. Then, the controller 112 starts a process of reporting an emergency.

During the emergency reporting process, the controller 112 reads out the positional information data (the positional history data) and the information of the telephone number of the emergency report receiving center from the memory 115. In addition, the controller 112 generates emergency-occurrence time data, that is, data representing the moment or time of the occurrence of the emergency. The controller 112 informs the communication device 111 of the telephone number of the emergency report receiving center. In addition, the controller 112 requires the communication device 111 to generate a radio signal in response to the telephone number to call the emergency report receiving center. Accordingly, the communication device 111 generates the radio call signal directed to the emergency report receiving center. The radio call signal contains a dial signal. The radio call signal is fed from the communication device 111 to the communication antenna 102 before being radiated thereby. The radio call signal propagates to a base station. The corresponding call signal is transmitted via the base station to the emergency report receiving center. Normally, an answer signal responsive to the call signal is transmitted from the emergency report receiving center to the base station. The corresponding radio answer signal is transmitted from the base station. The communication antenna 102 receives the radio answer signal. The received radio answer signal is fed from the communication antenna 102 to the communication device 111. The communication device 111 recognizes from the radio answer signal that connection with the emergency report receiving center is established. Then, the communication device 111 changes to the data communication mode of operation. In addition, the communication device 111 informs the controller 112 that the connection with the emergency report receiving center is established. Thus, the controller 112 decides that the connection with the emergency report receiving center has been successfully established.

Subsequently, the controller 112 operates to implement data communications. Specifically, the controller 112 feeds the positional information data (the positional history data) and the emergency-occurrence time data to the communication device 111. The controller 112 requires the communication device 111 to generate a radio signal containing the positional information data and the emergency-occurrence time data. Accordingly, the communication device 111 generates the radio data signal. The radio data signal is fed from the communication device 111 to the communication antenna 102 before being radiated thereby. The radio data signal propagates to the base station. The corresponding data signal is transmitted via the base station to the emergency report receiving center. In this way, the positional information data and the emergency-occurrence time data are transmitted to the emergency report receiving center on a data communication basis. After the data communications have been completed, the controller 112 operates to allow two-way speech communications between the user and an operator of the emergency report receiving center.

Normally, the power supply control circuit 117 feeds power only from the main battery 105 to the units 111, 112, 113, 114, 115, and 116 within the terminal device 101. When the voltage of fed power drops below the reference level, the power supply control circuit 117 outputs a signal representative of the voltage drop to the controller 112. The controller 112 outputs a control signal to the power supply control circuit 117 in response to the voltage-drop signal. The control signal causes the power supply control circuit 117 to use both the main battery 105 and the auxiliary battery 118 as power sources for the units 111, 112, 113, 114, 115, and 116. At the same time, the power supply control circuit 117 informs the controller 112 that the main battery 105 is helped by the auxiliary battery 118. Thus, the units 111, 112, 113, 114, 115, and 116 remain sufficiently powered even when the voltage of fed power drops below the reference level.

The controller 112 and the power supply control circuit 117 may be the controller 11 and the power supply control circuit 12 in FIG. 1. Alternatively, the controller 112 and the power supply control circuit 117 may be the controller 11A and the power supply control circuit 12A in FIG. 4.

The main battery 105 may be replaced by the auxiliary battery 118 when the voltage of the main battery 105 drops below a first threshold level. In this case, the auxiliary battery 118 is replaced by the main battery 105 when the voltage of the main battery 105 rises above a second threshold level higher than the first threshold level.

### Fourth Embodiment

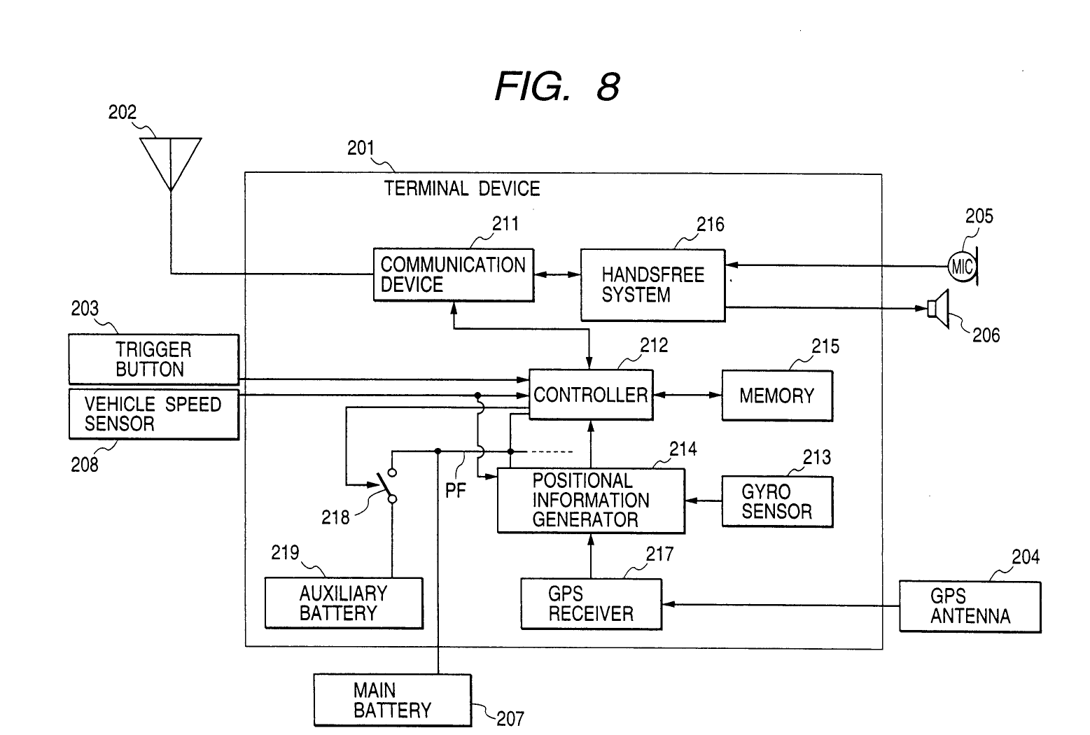

FIG. 8 shows an emergency reporting apparatus (a terminal apparatus) according to a fourth embodiment of this invention. The emergency reporting apparatus is mounted on a vehicle such as an automotive vehicle.

As shown in FIG. 8, the emergency reporting apparatus includes a terminal device 201, a communication antenna 202, a trigger button 203, a GPS (Global Positioning System) antenna 204, a microphone 205, and a loudspeaker 206. The terminal device 201 is connected to the communication antenna 202, the trigger button 203, the GPS antenna 204, the microphone 205, and the loudspeaker 206.

A vehicle speed sensor 208 is connected to the terminal device 201. A main battery 207 is connected to the terminal device 201. The main battery 207 may be a vehicle battery.

The terminal device 201 includes a communication device 211, a controller 212, a gyro sensor 213, a positional information generator 214, a memory 215, a handsfree system circuit 216, a GPS receiver 217, a switch 218, and an auxiliary battery 219. The communication device 211 is connected to the communication antenna 202, the controller 212, and the handsfree system circuit 216. The controller 212 is connected to the trigger button 203, the vehicle speed sensor 208, the positional information generator 214, the memory 215, and the switch 218. The gyro sensor 213 is connected to the positional information generator 214. The GPS receiver 217 is connected to the GPS antenna 204 and the positional information generator 214. The positional information generator 214 is connected to the vehicle speed sensor 208. The handsfree system circuit 216 is connected to the microphone 205 and the loudspeaker 206. The switch 218 is connected to the auxiliary battery 219 and a power feed line PF. The power feed line PF leads from the main battery 207. The power feed line PF is connected to the units 211, 212, 213, 214, 215, 216, and 217 within the terminal device 201.

The main battery 207 is provided with a back-current blocking diode at the connection with the power feed line PF. The auxiliary battery 219 is provided with a back-current blocking diode at the connection with the switch 218.

The trigger button 203 includes a manually-operated button which can be accessed by a user, that is, a driver or an occupant of the related vehicle. When the trigger button 203 is depressed, a trigger signal is transmitted from the trigger button 203 to the controller 212 as an emergency-occurrence indicating signal.

The GPS antenna 204 can receive GPS signals from GPS satellites. The GPS antenna 204 feeds the received GPS signals to the GPS receiver 217.

The communication device 211 includes a telephone set such as a mobile telephone set having a radio communication device which can be controlled by the controller 212. The communication device 211 can output and feed a radio signal to the communication antenna 202. The radio signal is radiated by the communication antenna 202. The radiated radio signal can propagate to a base station of a related radio telephone network. The communication antenna 202 can receive a radio signal from the base station. The received radio signal is fed from the communication antenna 202 to the communication device 211. In this way, the communication device 211 can communicate with the base station by radio on a two-way basis.

The communication device 211 can receive a call requirement signal and a destination-telephone-number signal from the controller 212. Upon the reception of the call requirement signal, the communication device 211 generates a radio signal to call the communication opposite party designated by the destination telephone number. The radio call signal contains a dial signal. The radio call signal is fed from the communication device 211 to the communication antenna 202 before being radiated thereby. The radio call signal propagates to a base station. The corresponding call signal is transmitted via the base station to the communication opposite party designated by the destination telephone number. Normally, an answer signal responsive to the call signal is transmitted from the communication opposite party to the base station. The corresponding radio answer signal is transmitted from the base station. The communication antenna 202 receives the radio answer signal. The received radio answer signal is fed from the communication antenna 202 to the communication device 211. The communication device 211 recognizes from the radio answer signal that connection with the communication opposite party is established. Then, the communication device 211 changes to a data communication mode of operation or a speech communication mode of operation. In addition, the communication device 211 informs the controller 212 that the connection with the communication opposite party is established.

The communication device 211 can receive, from the controller 212, positional information data representing the position of the related vehicle, the direction of travel of the related vehicle, and the orientation of the related vehicle. During the data communication mode of operation, the communication device 211 transmits the positional information data to the communication opposite party via the base station. The communication opposite party is, for example, a police station or an emergency report receiving center. During the speech communication mode of operation, the communication device 211 allows two-way speech communications between a user (a driver or an occupant of the related vehicle) and an operator of the communication opposite party via the base station.

The controller 212 includes a microcomputer, a CPU, or a similar device having a combination of an input/output port, a signal processing section, a RAM, and a ROM. The controller 212 operates in accordance with a program stored in the ROM. The controller 212 receives an output signal of the vehicle speed sensor 208 which represents the speed of the body of the related vehicle. As previously mentioned, the controller 212 is connected to the power feed line PF. The controller 212 has the function of detecting the voltage at the power feed line PF, that is, the +B voltage.

The gyro sensor 213 generates data representing the direction of travel of the related vehicle and the orientation of the related vehicle. The gyro sensor 213 outputs the generated data to the positional information generator 214. The GPS receiver 217 generates data representative of the position of the related vehicle in response to the GPS signals fed from the GPS antenna 204. The GPS receiver 217 outputs the generated data to the positional information generator 214. The positional information generator 214 receives the output signal of the vehicle speed sensor 208. The positional information generator 214 produces positional information data in response to the output data from the gyro sensor 213, the output data from the GPS receiver 217, and the output signal from the vehicle speed sensor 208. The produced positional information data represent the position of the related vehicle, the direction of travel of the related vehicle, and the orientation of the related vehicle. The positional information generator 214 can output the produced positional information data to the controller 212.

The memory 215 stores information representing the telephone numbers of police stations, the telephone numbers of emergency report receiving centers, the registration number of the related vehicle, and the registrant. The memory 215 can be accessed by the controller 212.

The microphone 205 can pick up voice of a user (a driver or an occupant of the related vehicle). The microphone 205 outputs an audio signal representative of the picked-up voice to the handsfree system circuit 216. The handsfree system circuit 216 can output an audio signal representative of operator's voice in the communication opposite party to the loudspeaker 206. The loudspeaker 206 converts the output audio signal of the handsfree system circuit 216 into corresponding sound which can be heard by the user. The handsfree system circuit 216 can transmit and receive voice information to and from the communication device 211.

The handsfree system circuit 216 cooperates with the microphone 205, the loudspeaker 206, and the communication device 211, thereby allowing handsfree two-way speech communications between a user (a driver or an occupant of the related vehicle) and an operator of the communication opposite party. The handsfree system circuit 216 has an echo cancel function and an anti-howling function.

The switch 218 constitutes a power supply control circuit. The switch 218 selectively connects and disconnects the auxiliary battery 219 to and from the power feed line PF in response to a control signal fed from the controller 212. Normally, the switch 218 disconnects the auxiliary battery 219 from the power feed line PF. Thus, the switch 218 is of a normally open type. In the case where the switch 218 disconnects the auxiliary battery 219 from the power feed line PF, electric power is fed only from the main battery 207 to the units 211, 212, 213, 214, 215, 216, and 217 within the terminal device 201. Thus, in this case, the units 211, 212, 213, 214, 215, 216, and 217 are activated by the electric power fed from the main battery 207 only. On the other hand, in the case where the switch 218 connects the auxiliary battery 219 to the power feed line PF, electric power is fed from both the main battery 207 and the auxiliary battery 219 to the units 211, 212, 213, 214, 215, 216, and 217 within the terminal device 201. Thus, in this case, the units 211, 212, 213, 214, 215, 216, and 217 are activated by the electric power fed from both the main battery 207 and the auxiliary battery 219.

The emergency reporting apparatus in FIG. 8 operates as follows. In the event of an emergency such as an accident or a sudden illness, the trigger button 203 can be depressed by a user (a driver or an occupant of the related vehicle). The depression of the trigger button 203 sends an emergency-occurrence indicating signal to the controller 212. The controller 212 recognizes from the emergency-occurrence indicating signal that an emergency occurs and the emergency should be reported. Then, the controller 212 starts a process of reporting an emergency.

During the emergency reporting process, the controller 212 outputs a signal to the positional information generator 214 which requires current positional information (information related to the current position of the related vehicle). In response to the output signal from the controller 212, the positional information generator 214 gets the current positional information. Then, the positional information generator 214 feeds the current positional information to the controller 212.

Specifically, the positional information generator 214 receives the output data from the gyro sensor 213. In addition, the positional information generator 214 receives the output data from the GPS receiver 217. Furthermore, the positional information generator 214 receives the output signal of the vehicle speed sensor 208. The positional information generator 214 produces positional information data in response to the output data from the gyro sensor 213, the output data from the GPS receiver 217, and the output signal from the vehicle speed sensor 208. The produced positional information data represent the current position of the related vehicle, the current direction of travel of the related vehicle, and the current orientation of the related vehicle. The positional information generator 214 outputs the produced positional information data to the controller 212 as the current positional information.

During the emergency reporting process, the controller 212 reads out information of a destination telephone number from the memory 215. The designation telephone number is equal to the telephone number of a desired communication opposite party (a police station or an emergency report receiving center). The controller 212 feeds the information of the destination telephone number to the communication device 211. The controller 212 requires the communication device 211 to generate a radio signal to call the communication opposite party designated by the destination telephone number. Accordingly, the communication device 211 generates the radio call signal. The radio call signal contains a dial signal. The radio call signal is fed from the communication device 211 to the communication antenna 202 before being radiated thereby. The radio call signal propagates to a base station. The corresponding call signal is transmitted via the base station to the communication opposite party designated by the destination telephone number. Normally, an answer signal responsive to the call signal is transmitted from the communication opposite party to the base station. The corresponding radio answer signal is transmitted from the base station. The communication antenna 202 receives the radio answer signal. The received radio answer signal is fed from the communication antenna 202 to the communication device 211. The communication device 211 recognizes from the radio answer signal that connection with the communication opposite party is established. Then, the communication device 211 changes to the data communication mode of operation. In addition, the communication device 211 informs the controller 212 that the connection with the communication opposite party is established. Thus, the controller 212 decides that the connection with the communication opposite party has been successfully established.

Subsequently, the controller 212 operates to implement data communications. Specifically, the controller 212 feeds the current positional information to the communication device 211. The controller 212 requires the communication device 211 to generate a radio signal of data of the current positional information. Accordingly, the communication device 211 generates the radio data signal. The radio data signal is fed from the communication device 211 to the communication antenna 202 before being radiated thereby. The radio data signal propagates to the base station. The corresponding data signal is transmitted via the base station to the communication opposite party. In this way, the current positional information is transmitted to the communication opposite party (the police station or the emergency report receiving center) on a data communication basis. After the data communications have been completed, the controller 212 operates to allow two-way speech communications.

During the two-way speech communications, an audio signal representative of operator's voice is transmitted from the communication opposite party to the base station. The corresponding radio speech signal is transmitted from the base station. The communication antenna 202 receives the radio speech signal. The received radio speech signal is fed from the communication antenna 202 to the communication device 211. The communication device 211 recovers an audio signal (a received audio signal) from the radio speech signal. The communication device 211 is controlled by the controller 212, outputting the received audio signal to the handsfree system circuit 216. The received audio signal represents operator's voice in the communication opposite party (the police station or the emergency report receiving center). The handsfree system circuit 216 subjects the received audio signal to an echo cancel process and an anti-howling process. The handsfree system circuit 216 outputs the resultant audio signal to the loudspeaker 206. The loudspeaker 206 converts the output audio signal of the handsfree system circuit 216 into corresponding sound which can be heard by the user (the driver or the occupant of the related vehicle).

During the two-way speech communications, the microphone 205 picks up voice of the user. The microphone 205 outputs an audio signal representative of the picked-up voice to the handsfree system circuit 216. The handsfree system circuit 216 subjects the audio signal to the echo cancel process and the anti-howling process. The handsfree system circuit 216 outputs the resultant audio signal (the resultant speech signal) to the communication device 211. The communication device 211 is controlled by the controller 212, generating a corresponding radio speech signal. The radio speech signal is fed from the communication device 211 to the communication antenna 202 before being radiated thereby. The radio speech signal propagates to the base station. The corresponding speech signal is transmitted via the base station to the communication opposite party. Thus, two-way speech communications are implemented between the user (the driver or the occupant of the related vehicle) and the operator of the communication opposite party (the police station or the emergency report receiving center).

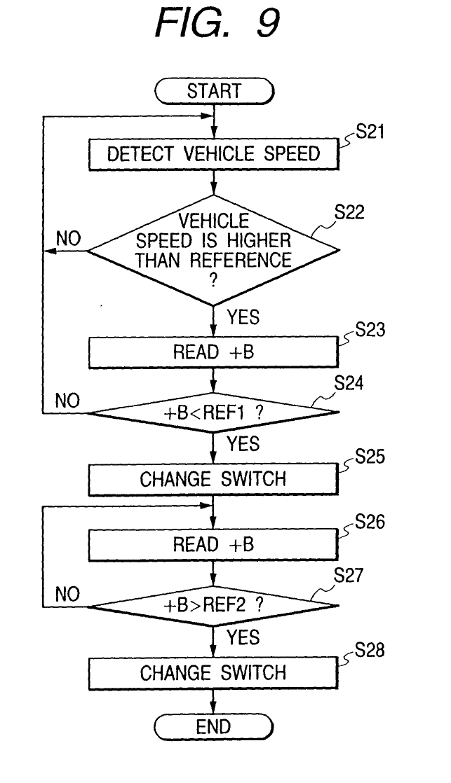

FIG. 9 is a flowchart of a segment of a program for the controller 212. The program segment in FIG. 9 may be periodically executed on a timer-based interruption basis.

As shown in FIG. 9, a first step S21 of the program segment detects the present speed of the related vehicle by referring to the output signal of the vehicle speed sensor 208.

A step S22 following the step S21 decides the detected vehicle speed is higher than a predetermined reference speed. When the detected vehicle speed is higher than the reference speed, the program advances from the step S22 to a step S23. Otherwise, the program returns from the step S22 to the step S21. The reference speed is higher than 0 km/h. The reference speed is equal to, for example, 5 km/h or 10 km/h.

The step S23 detects the present +B voltage (the present voltage at the power feed line PF). A step S24 subsequent to the step S23 decides whether or not the present +B voltage drops below a first reference voltage. The first reference voltage is preset to be higher than the minimum voltage necessary for normal operation of the units within the terminal device 201. When the present +B voltage drops below the first reference voltage, the program advances from the step S24 to a step S25. Otherwise, the program returns from the step S24 to the step S21.

The step S25 changes or closes the switch 218 to connect the auxiliary battery 219 to the power feed line PF. Therefore, the main battery 207 is helped by the auxiliary battery 219, and the units within the terminal device 201 are now activated by the electric power fed from both the main battery 207 and the auxiliary battery 219. Thus, the units within the terminal device 201 remain sufficiently powered even when the +B voltage drops below the first reference voltage. After the step S25, the program advances to a step S26.

The step S26 detects the present +B voltage. A step S27 following the step S26 decides whether or not the present +B voltage rises above a second reference voltage. The second reference voltage is preset to be higher than the first reference voltage. When the +B voltage rises above the second reference voltage, the program advances from the step S27 to a step S28. Otherwise, the program returns from the step S27 to the step S26.

The step S28 changes or opens the switch 218 to disconnect the auxiliary battery 219 from the power feed line PF. Therefore, the units within the terminal device 201 are now activated by the electric power fed from the main battery 207 only. After the step S28, the current execution cycle of the program segment ends.

It should be noted that the main battery 207 may be replaced by the auxiliary battery 219 when the voltage of the main battery 207 drops below a first threshold level. In this case, the auxiliary battery 219 is replaced by the main battery 207 when the voltage of the main battery 207 rises above a second threshold level higher than the first threshold level.

### Fifth Embodiment

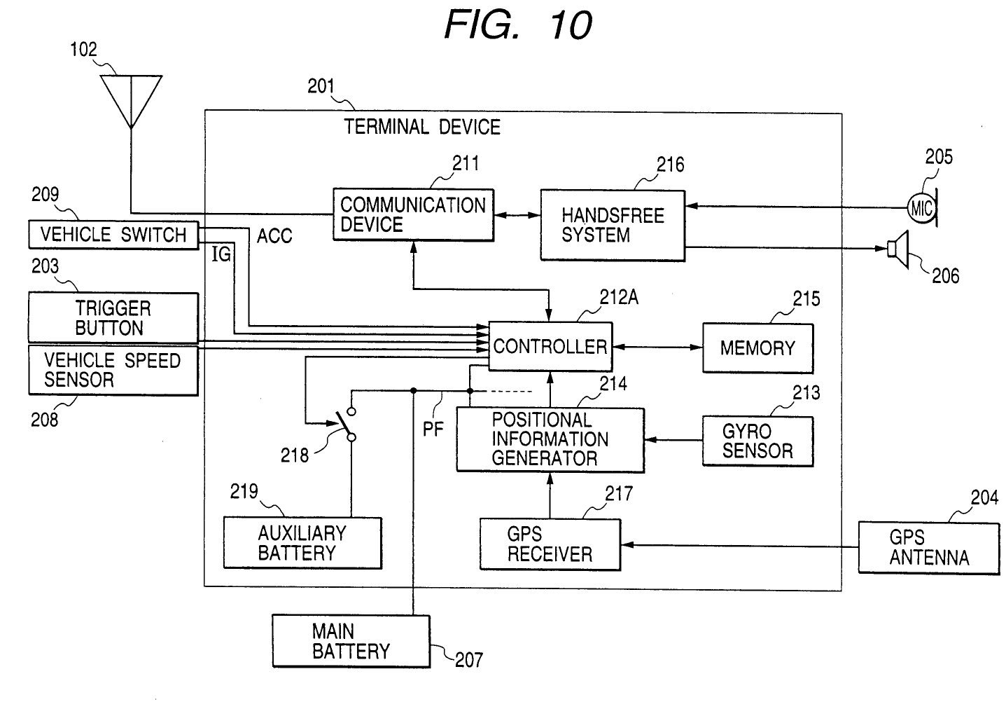

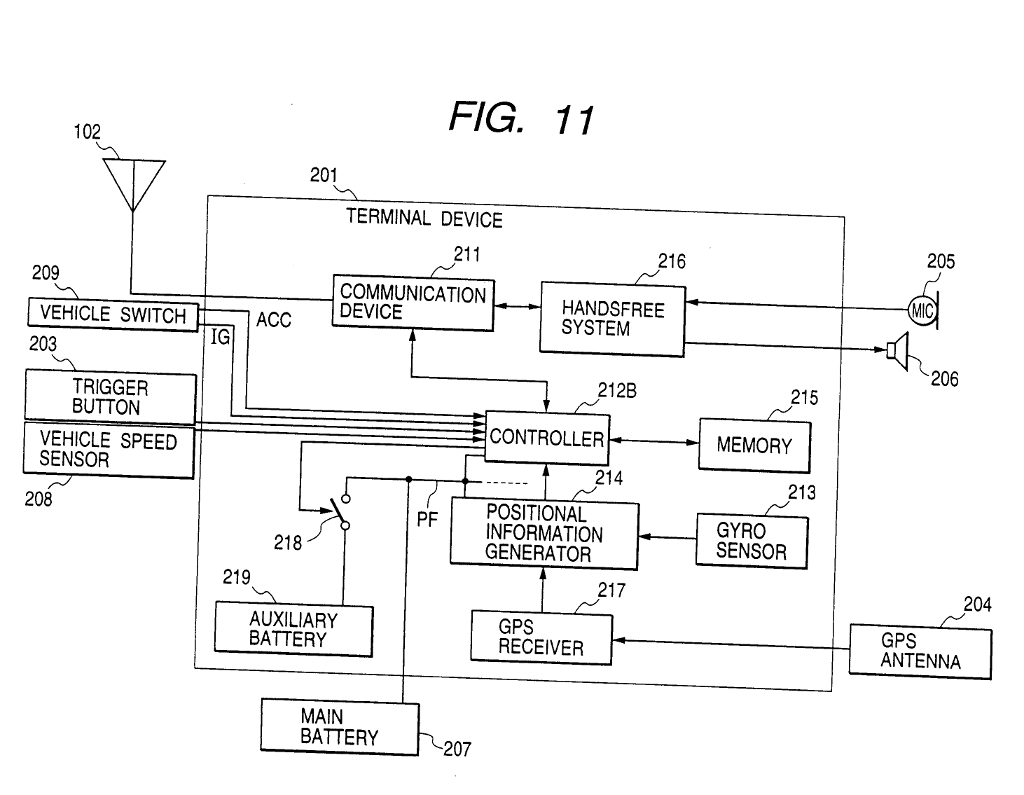

FIG. 10 shows an emergency reporting apparatus (a terminal apparatus) according to a fifth embodiment of this invention. The emergency reporting apparatus in FIG. 10 is similar to the emergency reporting apparatus in FIG. 8 except for design changes mentioned hereinafter. The emergency reporting apparatus in FIG. 10 includes a controller 212A instead of the controller 212 (see FIG. 8). A vehicle switch 209 such as an ignition switch or an engine key switch is connected to the controller 212A. The vehicle switch 209 outputs a first signal to the controller 212A which represents whether a vehicle accessary (ACC) is in an on state or an off state. The vehicle switch 209 outputs a second signal to the controller 212A which represents whether a vehicle engine ignition system (IG) is in an on state or an off state.

In the case where at least one of the ACC and the IG is in its off state, the controller 212A holds a switch 218 open and thereby continues an auxiliary battery 207 to be disconnected from a power feed line PF regardless of a +B voltage (a voltage at the power feed line PF) and a vehicle speed. Thus, in this case, the auxiliary battery 207 remains inhibited from feeding electric power to units within a terminal device 201.

### Sixth Embodiment

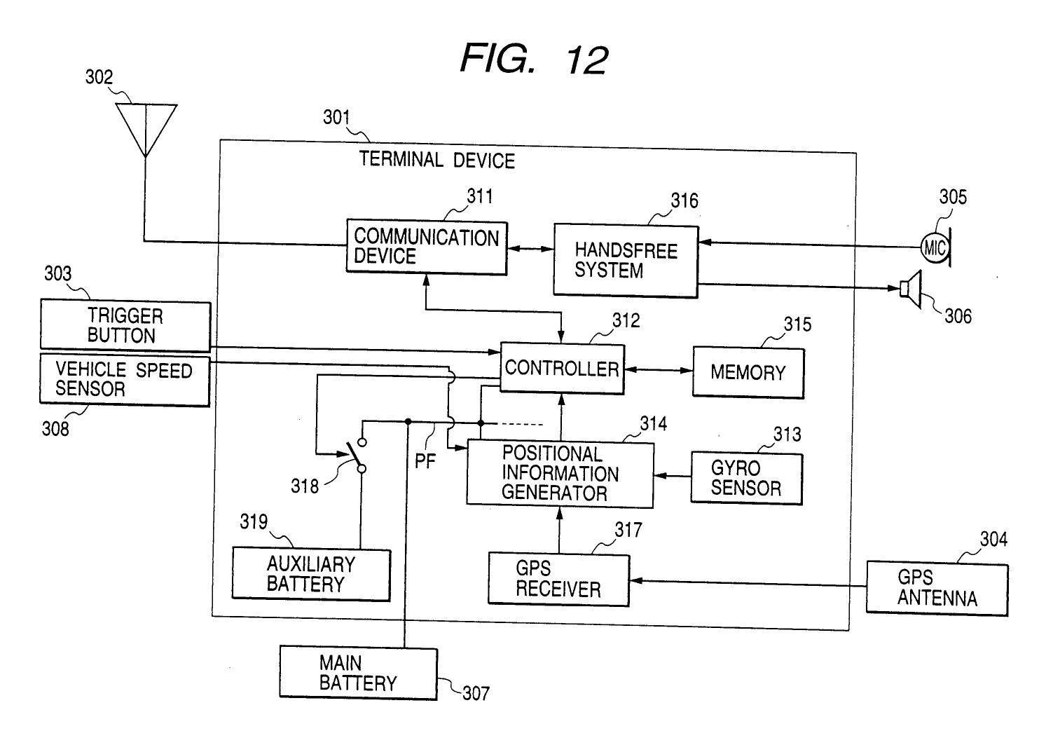

FIG. 11 shows an emergency reporting apparatus (a terminal apparatus) according to a sixth embodiment of this invention. The emergency reporting apparatus in FIG. 11 is similar to the emergency reporting apparatus in FIG. 10 except for design changes mentioned hereinafter. The emergency reporting apparatus in FIG. 11 includes a controller 212B instead of the controller 212A (see FIG. 10). The controller 212B has the function of measuring a time elapsed since the moment at which an ACC changes from its off state to its on state. In addition, the controller 212B has the function of deciding whether or not the elapsed time reaches a predetermined reference time.

A vehicle switch 209 informs the controller 212B of whether a vehicle engine ignition is in an on state or an off state. The controller 212B has the function of measuring a time elapsed since the moment at which the vehicle engine ignition changes from its off state to its on state. In addition, the controller 212B has the function of deciding whether or not the elapsed time reaches a preset reference time.

In the case where at least one of first, second, and third conditions is met, when the present voltage at a power feed line PF (the present +B voltage) drops below a first reference voltage, the controller 212B closes or closes a switch 218 to connect an auxiliary battery 207 to a power feed line PF. Thus, in this case, the auxiliary battery 207 helps a main battery 207 and feeds electric power to units within a terminal device 201. The previously-indicated first condition is that the present vehicle speed is higher than a predetermined reference speed. The previously-indicated second condition is that the time elapsed since the moment of the change of the ACC to its on state reaches the reference time. The previously-indicated third condition is that the time elapsed since the moment of the change of the vehicle engine ignition to its on state reaches the reference time.

In the case where the ACC is in its off state, the controller 212B opens the switch 218 to disconnect the auxiliary battery 207 from the power feed line PF regardless of the +B voltage (the voltage at the power feed line PF) and the present vehicle speed. Thus, in this case, the auxiliary battery 207 remains inhibited from feeding electric power to the units within the terminal device 201.

### Seventh Embodiment

FIG. 12 shows an emergency reporting apparatus (a terminal apparatus) according to a seventh embodiment of this invention. The emergency reporting apparatus is mounted on a vehicle such as an automotive vehicle.

As shown in FIG. 12, the emergency reporting apparatus includes a terminal device 301, a communication antenna 302, a trigger button 303, a GPS (Global Positioning System) antenna 304, a microphone 305, and a loudspeaker 306. The terminal device 301 is connected to the communication antenna 302, the trigger button 303, the GPS antenna 304, the microphone 305, and the loudspeaker 306.

A vehicle speed sensor 308 is connected to the terminal device 301. A main battery 307 is connected to the terminal device 301. The main battery 307 may be a vehicle battery.

The terminal device 301 includes a communication device 311, a controller 312, a gyro sensor 313, a positional information generator 314, a memory 315, a handsfree system circuit 316, a GPS receiver 317, a switch 318, and an auxiliary battery 319. The communication device 311 is connected to the communication antenna 302, the controller 312, and the handsfree system circuit 316. The controller 312 is connected to the trigger button 303, the positional information generator 314, the memory 315, and the switch 318. The gyro sensor 313 is connected to the positional information generator 314. The GPS receiver 317 is connected to the GPS antenna 304 and the positional information generator 314. The positional information generator 314 is connected to the vehicle speed sensor 308. The handsfree system circuit 316 is connected to the microphone 305 and the loudspeaker 306. The switch 318 is connected to the auxiliary battery 319 and a power feed line PF. The power feed line PF leads from the main battery 307. The power feed line PF is connected to the units 311, 312, 313, 314, 315, 316, and 317 within the terminal device 301.

The main battery 307 is provided with a back-current blocking diode at the connection with the power feed line PF. The auxiliary battery 319 is provided with a back-current blocking diode at the connection with the switch 318.

The trigger button 303 includes a manually-operated button which can be accessed by a user, that is, a driver or an occupant of the related vehicle. When the trigger button 303 is depressed, a trigger signal is transmitted from the trigger button 303 to the controller 312 as an emergency-occurrence indicating signal.

The GPS antenna 304 can receive GPS signals from GPS satellites. The GPS antenna 304 feeds the received GPS signals to the GPS receiver 317.

The communication device 311 includes a telephone set such as a mobile telephone set having a radio communication device which can be controlled by the controller 312. The communication device 311 can output and feed a radio signal to the communication antenna 302. The radio signal is radiated by the communication antenna 302. The radiated radio signal can propagate to a base station of a related radio telephone network. The communication antenna 302 can receive a radio signal from the base station. The received radio signal is fed from the communication antenna 302 to the communication device 311. In this way, the communication device 311 can communicate with the base station by radio on a two-way basis.

The communication device 311 can receive a call requirement signal and a destination-telephone-number signal from the controller 312. Upon the reception of the call requirement signal, the communication device 311 generates a radio signal to call the communication opposite party designated by the destination telephone number. The radio call signal contains a dial signal. The radio call signal is fed from the communication device 311 to the communication antenna 302 before being radiated thereby. The radio call signal propagates to a base station. The corresponding call signal is transmitted via the base station to the communication opposite party designated by the destination telephone number. Normally, an answer signal responsive to the call signal is transmitted from the communication opposite party to the base station. The corresponding radio answer signal is transmitted from the base station. The communication antenna 302 receives the radio answer signal. The received radio answer signal is fed from the communication antenna 302 to the communication device 311. The communication device 311 recognizes from the radio answer signal that connection with the communication opposite party is established. Then, the communication device 311 changes to a data communication mode of operation or a speech communication mode of operation. In addition, the communication device 311 informs the controller 312 that the connection with the communication opposite party is established.

The communication device 311 can receive, from the controller 312, positional information data representing the position of the related vehicle, the direction of travel of the related vehicle, and the orientation of the related vehicle. During the data communication mode of operation, the communication device 311 transmits the positional information data to the communication opposite party via the base station. The communication opposite party is, for example, a police station or an emergency report receiving center. During the speech communication mode of operation, the communication device 311 allows two-way speech communications between a user (a driver or an occupant of the related vehicle) and an operator of the communication opposite party via the base station.

The controller 312 includes a microcomputer, a CPU, or a similar device having a combination of an input/output port, a signal processing section, a RAM, and a ROM. The controller 312 operates in accordance with a program stored in the ROM. As previously mentioned, the controller 312 is connected to the power feed line PF. The controller 312 has the function of detecting the voltage at the power feed line PF, that is, the +B voltage.

The gyro sensor 313 generates data representing the direction of travel of the related vehicle and the orientation of the related vehicle. The gyro sensor 313 outputs the generated data to the positional information generator 314. The GPS receiver 317 generates data representative of the position of the related vehicle in response to the GPS signals fed from the GPS antenna 304. The GPS receiver 317 outputs the generated data to the positional information generator 314. The positional information generator 314 receives the output signal of the vehicle speed sensor 308. The positional information generator 314 produces positional information data in response to the output data from the gyro sensor 313, the output data from the GPS receiver 317, and the output signal from the vehicle speed sensor 308. The produced positional information data represent the position of the related vehicle, the direction of travel of the related vehicle, and the orientation of the related vehicle. The positional information generator 314 can output the produced positional information data to the controller 312.

The memory 315 stores information representing the telephone numbers of police stations, the telephone numbers of emergency report receiving centers, the registration number of the related vehicle, and the registrant. The memory 315 can be accessed by the controller 312.

The microphone 305 can pick up voice of a user (a driver or an occupant of the related vehicle). The microphone 305 outputs an audio signal representative of the picked-up voice to the handsfree system circuit 316. The handsfree system circuit 316 can output an audio signal representative of operator's voice in the communication opposite party to the loudspeaker 306. The loudspeaker 306 converts the output audio signal of the handsfree system circuit 316 into corresponding sound which can be heard by the user. The handsfree system circuit 316 can transmit and receive voice information to and from the communication device 311.

The handsfree system circuit 316 cooperates with the microphone 305, the loudspeaker 306, and the communication device 311, thereby allowing handsfree two-way speech communications between a user (a driver or an occupant of the related vehicle) and an operator of the communication opposite party. The handsfree system circuit 316 has an echo cancel function and an anti-howling function.

The switch 318 constitutes a power supply control circuit. The switch 318 selectively connects and disconnects the auxiliary battery 319 to and from the power feed line PF in response to a control signal fed from the controller 312. Normally, the switch 318 disconnects the auxiliary battery 319 from the power feed line PF. Thus, the switch 318 is of a normally open type. In the case where the switch 318 disconnects the auxiliary battery 319 from the power feed line PF, electric power is fed only from the main battery 307 to the units 311, 312, 313, 314, 315, 316, and 317 within the terminal device 301. Thus, in this case, the units 311, 312, 313, 314, 315, 316, and 317 are activated by the electric power fed from the main battery 307 only. On the other hand, in, the case where the switch 318 connects the auxiliary battery 319 to the power feed line PF, electric power is fed from both the main battery 307 and the auxiliary battery 319 to the units 311, 312, 313, 314, 315, 316, and 317 within the terminal device 301. Thus, in this case, the units 311, 312, 313, 314, 315, 316, and 317 are activated by the electric power fed from both the main battery 307 and the auxiliary battery 319.

The controller 312 generates a first signal representing the number of times of use of the auxiliary battery 319 which means the number of times the auxiliary battery 319 is connected to the power feed line PF. The controller 312 generates a second signal representing the length of every time interval during which the auxiliary battery 319 remains used or connected to the power feed line PF. The controller 312 generates a third signal representing the sum of the time intervals during which the auxiliary battery 319 remains used or connected to the power feed line PF. The controller 312 stores the first signal, the second signal, and the third signal into the memory 315. The first signal, the second signal, and the third signal indicate the amount of consumed electric power related to the auxiliary battery 319.

The emergency reporting apparatus in FIG. 12 operates as follows. In the event of an emergency such as an accident or a sudden illness, the trigger button 303 can be depressed by a user (a driver or an occupant of the related vehicle). The depression of the trigger button 303 sends an emergency-occurrence indicating signal to the controller 312. The controller 312 recognizes from the emergency-occurrence indicating signal that an emergency occurs and the emergency should be reported. Then, the controller 312 starts a process of reporting an emergency.

During the emergency reporting process, the controller 312 outputs a signal to the positional information generator 314 which requires current positional information (information related to the current position of the related vehicle). In response to the output signal from the controller 312, the positional information generator 314 gets the current positional information. Then, the positional information generator 314 feeds the current positional information to the controller 312.

Specifically, the positional information generator 314 receives the output data from the gyro sensor 313. In addition, the positional information generator 314 receives the output data from the GPS receiver 317. Furthermore, the positional information generator 314 receives the output signal of the vehicle speed sensor 308. The positional information generator 314 produces positional information data in response to the output data from the gyro sensor 313, the output data from the GPS receiver 317, and the output signal from the vehicle speed sensor 308. The produced positional information data represent the current position of the related vehicle, the current direction of travel of the related vehicle, and the current orientation of the related vehicle. The positional information generator 314 outputs the produced positional information data to the controller 312 as the current positional information.

During the emergency reporting process, the controller 312 reads out information of a destination telephone number from the memory 315. The designation telephone number is equal to the telephone number of a desired communication opposite party (a police station or an emergency report receiving center). The controller 312 feeds the information of the destination telephone number to the communication device 311. The controller 312 requires the communication device 311 to generate a radio signal to call the communication opposite party designated by the destination telephone number. Accordingly, the communication device 311 generates the radio call signal. The radio call signal contains a dial signal. The radio call signal is fed from the communication device 311 to the communication antenna 302 before being radiated thereby. The radio call signal propagates to a base station. The corresponding call signal is transmitted via the base station to the communication opposite party designated by the destination telephone number. Normally, an answer signal responsive to the call signal is transmitted from the communication opposite party to the base station. The corresponding radio answer signal is transmitted from the base station. The communication antenna 302 receives the radio answer signal. The received radio answer signal is fed from the communication antenna 302 to the communication device 311. The communication device 311 recognizes from the radio answer signal that connection with the communication opposite party is established. Then, the communication device 311 changes to the data communication mode of operation. In addition, the communication device 311 informs the controller 312 that the connection with the communication opposite party is established. Thus, the controller 312 decides that the connection with the communication opposite party has been successfully established.

Subsequently, the controller 312 operates to implement data communications. Specifically, the controller 312 feeds the current positional information to the communication device 311. The controller 312 requires the communication device 311 to generate a radio signal of data of the current positional information. Accordingly, the communication device 311 generates the radio data signal. The radio data signal is fed from the communication device 311 to the communication antenna 302 before being radiated thereby. The radio data signal propagates to the base station. The corresponding data signal is transmitted via the base station to the communication opposite party. In this way, the current positional information is transmitted to the communication opposite party (the police station or the emergency report receiving center) on a data communication basis. After the data communications have been completed, the controller 312 operates to allow two-way speech communications.

During the two-way speech communications, an audio signal representative of operator's voice is transmitted from the communication opposite party to the base station. The corresponding radio speech signal is transmitted from the base station. The communication antenna 302 receives the radio speech signal. The received radio speech signal is fed from the communication antenna 302 to the communication device 311. The communication device 311 recovers an audio signal (a received audio signal) from the radio speech signal. The communication device 311 is controlled by the controller 312, outputting the received audio signal to the handsfree system circuit 316. The received audio signal represents operator's voice in the communication opposite party (the police station or the emergency report receiving center). The handsfree system circuit 316 subjects the received audio signal to an echo cancel process and an anti-howling process. The handsfree system circuit 316 outputs the resultant audio signal to the loudspeaker 306. The loudspeaker 306 converts the output audio signal of the handsfree system circuit 316 into corresponding sound which can be heard by the user (the driver or the occupant of the related vehicle).

During the two-way speech communications, the microphone 305 picks up voice of the user. The microphone 305 outputs an audio signal representative of the picked-up voice to the handsfree system circuit 316. The handsfree system circuit 316 subjects the audio signal to the echo cancel process and the anti-howling process. The handsfree system circuit 316 outputs the resultant audio signal (the resultant speech signal) to the communication device 311. The communication device 311 is controlled by the controller 312, generating a corresponding radio speech signal. The radio speech signal is fed from the communication device 311 to the communication antenna 302 before being radiated thereby. The radio speech signal propagates to the base station. The corresponding speech signal is transmitted via the base station to the communication opposite party. Thus, two-way speech communications are implemented between the user (the driver or the occupant of the related vehicle) and the operator of the communication opposite party (the police station or the emergency report receiving center).

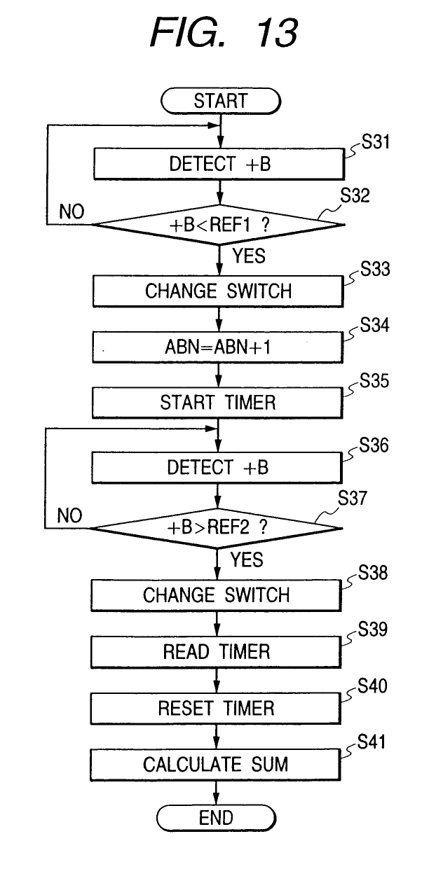

FIG. 13 is a flowchart of a segment of a program for the controller 312. The program segment in FIG. 13 may be periodically executed on a timer-based interruption basis.

As shown in FIG. 13, a first step S31 of the program segment detects the present +B voltage (the present voltage at the power feed line PF).

A step S32 following the step S31 decides whether or not the present +B voltage drops below a first reference voltage. The first reference voltage is preset to be higher than the minimum voltage necessary for normal operation of the units within the terminal device 301. When the present +B voltage drops below the first reference voltage, the program advances from the step S32 to a step S33. Otherwise, the program returns from the step S32 to the step S31.

The step S33 changes or closes the switch 318 to connect the auxiliary battery 319 to the power feed line PF. Therefore, the main battery 307 is helped by the auxiliary battery 319, and the units within the terminal device 301 are now activated by the electric power fed from both the main battery 307 and the auxiliary battery 319. Thus, the units within the terminal device 301 remain sufficiently powered even when the +B voltage drops below the first reference voltage.

A step S34 subsequent to the step S33 increments the value ABN by “1”. The value ABN indicates the number of times the auxiliary battery 319 is used or connected to the power feed line PF. It should be noted that an initial value of ABN has been set to “0” during a previous initialization process. The step S34 stores a signal representative of the resultant value ABN into the memory 315.

A step S35 following the step S34 starts a timer from “0”. The timer indicates the length of a time elapsed since the moment at which the auxiliary battery 319 is connected to the power feed line PF by the step S33. After the step S35, the program advances to a step S36.

The step S36 detects the present +B voltage. A step S37 subsequent to the step S36 decides whether or not the present +B voltage rises above a second reference voltage. The second reference voltage is preset to be higher than the first reference voltage. When the +B voltage rises above the second reference voltage, the program advances from the step S37 to a step S38. Otherwise, the program returns from the step S37 to the step S36.

The step S38 changes or opens the switch 318 to disconnect the auxiliary battery 319 from the power feed line PF. Therefore, the units within the terminal device 301 are now activated by the electric power fed from the main battery 307 only.

A step S39 following the step S38 reads the length of the elapsed time represented by the timer. The read length of the elapsed time means the length of the time interval during which the auxiliary battery 319 remains used or connected to the power feed line PF. The step S39 stores a signal representative of the time-interval length into the memory 315.

A step S40 subsequent to the step S39 resets the timer to “0”. A step S41 following the step S40 reads out, from the memory 315, all the signals representing the lengths of the time intervals during which the auxiliary battery 319 remains used or connected to the power feed line PF. The step S41 calculates the sum of the time-interval lengths. The step S41 stores a signal representative of the sum of the time-interval lengths into the memory 315. After the step S41, the current execution cycle of the program segment ends.

It should be noted that the main battery 307 may be replaced by the auxiliary battery 319 when the voltage of the main battery 307 drops below a first threshold level. In this case, the auxiliary battery 319 is replaced by the main battery 307 when the voltage of the main battery 307 rises above a second threshold level higher than the first threshold level.

The memory 315 may include a nonvolatile memory such as an EEP-ROM. In this case, even after power feed to the memory 315 stops, the memory 315 continues to hold the stored signals and data which include the signal representing the number of times of use of the auxiliary battery 319, the signal representing the length of every time interval during which the auxiliary battery 319 remains used or connected to the power feed line PF, and the signal representing the sum of the lengths of the time intervals during which the auxiliary battery 319 remains used or connected to the power feed line PF.

### Eighth Embodiment

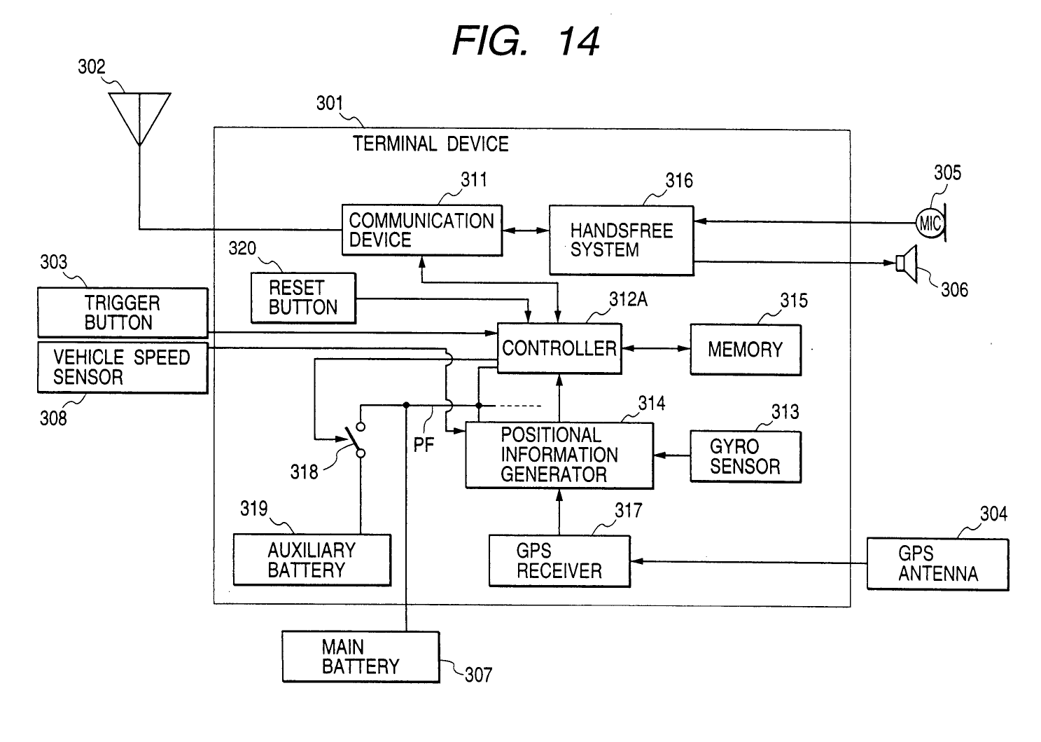

FIG. 14 shows an emergency reporting apparatus (a terminal apparatus) according to an eighth embodiment of this invention. The emergency reporting apparatus in FIG. 14 is similar to the emergency reporting apparatus in FIG. 12 except for design changes mentioned hereinafter. The emergency reporting apparatus in FIG. 14 includes a controller 312A instead of the controller 312 (see FIG. 12). In addition, the emergency reporting apparatus in FIG. 13 includes a reset button 320 connected to the controller 312A.

The reset button 320 can be accessed by a user. The reset button 320 outputs a reset requirement signal to the controller 312A when being actuated. In general, the reset button 320 is actuated when an auxiliary battery 319 is replaced by a new one.

A memory 315 stores a first signal representing the number of times of use of the auxiliary battery 319, a second signal representing the length of every time interval during which the auxiliary battery 319 remains used or connected to a power feed line PF, and a third signal representing the sum of the lengths of the time intervals during which the auxiliary battery 319 remains used or connected to the power feed line PF. The controller 312A accesses the memory 315 in response to the reset requirement signal, and resets the first, second, and third signals to their initial states. Specifically, the controller 312A resets the number of times of use of the auxiliary battery 319 to an initial number of “0”. In addition, the controller 312A resets the time-interval lengths to initial values of “0”. Furthermore, the controller 312A resets the sum of the lengths of the time intervals to an initial value of “0”.

### Ninth Embodiment

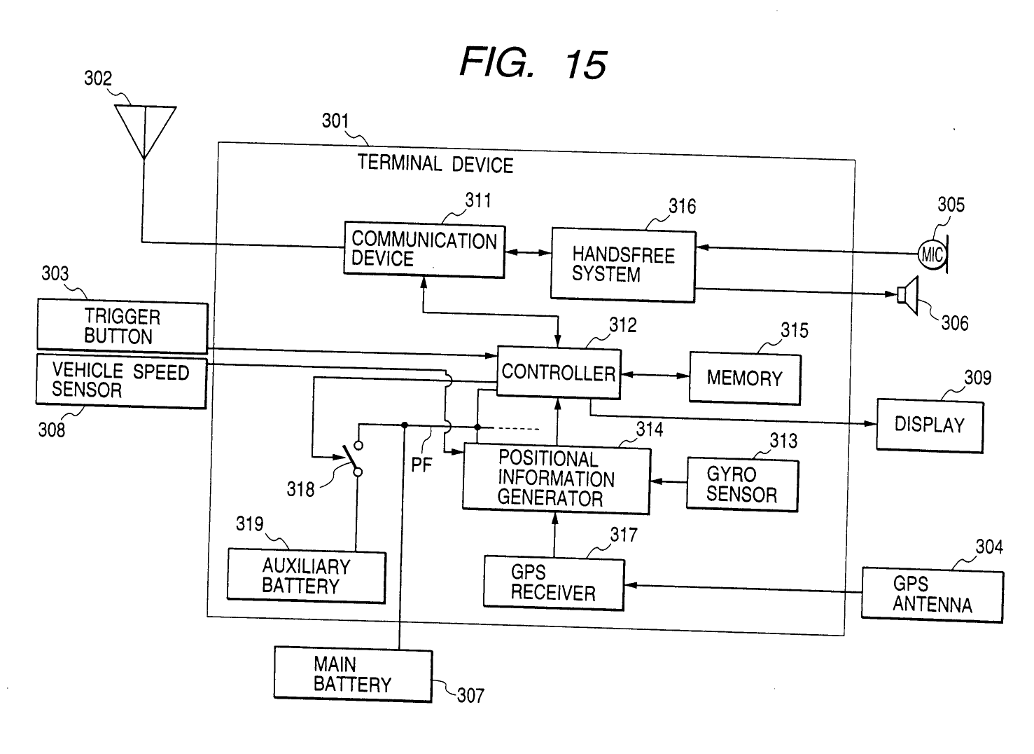

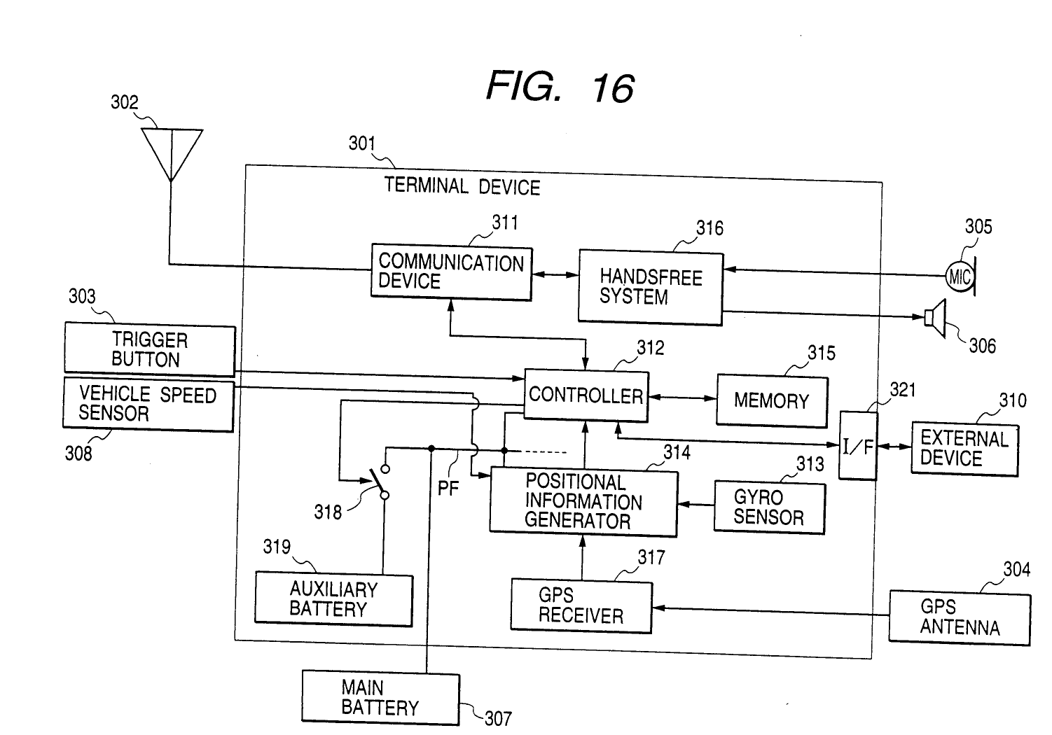

FIG. 15 shows an emergency reporting apparatus (a terminal apparatus) according to a ninth embodiment of this invention. The emergency reporting apparatus in FIG. 15 is similar to the emergency reporting apparatus in FIG. 12 except for design changes mentioned hereinafter. The emergency reporting apparatus in FIG. 15 includes a controller 312B instead of the controller 312 (see FIG. 12). In addition, the emergency reporting apparatus in FIG. 15 includes a display 309 connected to the controller 312B.

A memory 315 stores a first signal representing the number of times of use of an auxiliary battery 319, a second signal representing the length of every time interval during which the auxiliary battery 319 remains used or connected to a power feed line PF, and a third signal representing the sum of the lengths of the time intervals during which the auxiliary battery 319 remains used or connected to the power feed line PF.

The controller 312B can transmit the first, second, and third signals from the memory 315 to the display 309. The display 309 can indicate the number of times of use of the auxiliary battery 319, the lengths of the time intervals, and the sum of the lengths of the time intervals which are represented by the first, second, and third signals.

The controller 312B can read the first, second, and third signals from the memory 315. The controller 312B can decide whether or not the number of times which is represented by the first signal exceeds a predetermined reference number of times. When the number of times which is represented by the first signal exceeds the reference number of times, the controller 312B outputs a warning signal to the display 309. The controller 312B can decide whether or not the length of every time interval which is represented by the second signal exceeds a predetermined reference length. When the length of every time interval which is represented by the second signal exceeds the reference length, the controller 312B outputs a warning signal to the display 309. The controller 312B can decide whether or not the sum of the lengths of the time intervals which is represented by the third signal exceeds a predetermined reference value. When the sum of the lengths of the time intervals which is represented by the third signal exceeds the reference value, the controller 312B outputs a warning signal to the display 309. The display 309 indicates a warning when receiving a warning signal from the controller 312B.

Regarding the warning process, the display 309 may be replaced by an illumination device, an LED, a sound generating device, or a buzzer.

### Tenth Embodiment

FIG. 16 shows an emergency reporting apparatus (a terminal apparatus) according to a tenth embodiment of this invention. The emergency reporting apparatus in FIG. 16 is similar to the emergency reporting apparatus in FIG. 12 except for design changes mentioned hereinafter. The emergency reporting apparatus in FIG. 16 includes a controller 312C instead of the controller 312 (see FIG. 12). In addition, the emergency reporting apparatus in FIG. 16 includes an interface 321 connected to the controller 312C. An external device 310 is connected to the interface 321.

A memory 315 stores a first signal Representing the number of times of use of an auxiliary battery 319, a second signal representing the length of every time interval during which the auxiliary battery 319 remains used or connected to a power feed line PF, and a third signal representing the sum of the lengths of the time intervals during which the auxiliary battery 319 remains used or connected to the power feed line PF.

The external device 310 can feed a data requirement signal to the controller 312C via the interface 321. The controller 312C reads out the first, second, and third signals from the memory 315 in response to the data requirement signal. Then, the controller 312C transmits the first, second, and third signals to the external device 310 via the interface 321.

In this way, the external device 310 and the controller 312C can communicate with each other via the interface 321. Preferably, a serial-signal format is used for signals transmitted during the communications between the external device 310 and the controller 312C.

What is claimed is:

1. An on-vehicle radio-communication terminal apparatus comprising:
first means for using a main battery as a power supply and for receiving electric power from the power supply;
an auxiliary battery;
second means for deciding whether or not a voltage of the electric power from the power supply drops below a predetermined reference level; and
third means for using the auxiliary battery as at least part of the power supply when the second means decides that the voltage of the electric power from the power supply drops below the predetermined reference level.

2. An on-vehicle radio-communication terminal apparatus as recited in claim 1, wherein the second means comprises an analog-to-digital converter for changing the voltage of the electric power into a corresponding digital signal, and means for comparing the digital signal with data representing the predetermined reference level.

3. An on-vehicle radio-communication terminal apparatus as recited in claim 1, wherein the second means comprises a comparator for comparing the voltage of the electric power with the predetermined reference level.

4. An on-vehicle radio-communication terminal apparatus as recited in claim 1, further comprising fourth means for repetitively enabling the second means to execute the deciding on an interruption basis.

5. An on-vehicle radio-communication terminal apparatus as recited in claim 1, wherein the predetermined reference level is higher than a minimum level necessary for operation.

6. An on-vehicle radio-communication terminal apparatus as recited in claim 1, wherein the second means comprises a voltage divider for dividing the voltage of the electric power by a predetermined value and generating a signal representative of a result of the dividing, an analog-to-digital converter for changing the dividing-result signal into a corresponding digital signal, and means for comparing the digital signal with data corresponding to the predetermined reference level.

7. An on-vehicle radio-communication terminal apparatus as recited in claim 1, further comprising fourth means for deciding whether or not the voltage of the electric power from the power supply rises above a predetermined criterion level, and fifth means for stopping the third means from using the auxiliary battery as at least part of the power supply when the fourth means decides that the voltage of the electric power from the power supply rises above the predetermined criterion level.

8. An on-vehicle radio-communication terminal apparatus as recited in claim 7, wherein the predetermined criterion level is higher than the predetermined reference level.

9. An emergency reporting apparatus including the on-vehicle radio-communication terminal apparatus of one of claims 1-8.

10. An emergency reporting network system comprising:
an emergency report receiving center;
a communication network; and
emergency reporting apparatuses connectable with the emergency report receiving center via the communication network;
wherein each of the emergency reporting apparatuses comprises the emergency reporting apparatus of claim 9.

11. An emergency reporting apparatus for a vehicle having a sensor detecting a speed of a body of the vehicle, the apparatus comprising:
first means for using a main battery as a power supply and for receiving electric power from the power supply;
an auxiliary battery;
second means for using the auxiliary battery as at least part of the power supply;
third means for deciding whether or not the detected vehicle speed exceeds a predetermined reference speed; and
fourth means for permitting the second means to use the auxiliary battery as at least part of the power supply when the third means decides that the detected vehicle speed exceeds the predetermined reference speed.

12. An emergency reporting apparatus as recited in claim 11, further comprising fifth means for inhibiting the second means from using the auxiliary battery as at least part of the power supply when the third means decides that the detected vehicle speed does not exceed the predetermined reference speed.

13. An emergency reporting apparatus as recited in claim 11, further comprising fifth means for deciding whether or not a vehicle accessory changes from its on state to its off state, sixth means for inhibiting the second means from using the auxiliary battery as at least part of the power supply when the fifth means decides that the vehicle accessory changes from its on state to its off state, seventh means for deciding whether or not a vehicle engine ignition system changes from its on state to its off state, and eighth means for inhibiting the second means from using the auxiliary battery as at least part of the power supply when the seventh means decides that the vehicle engine ignition system changes from its on state to its off state.

14. An emergency reporting apparatus for a vehicle having an accessory, an engine ignition, and a sensor detecting a speed of a body of the vehicle, the apparatus comprising:
first means for using a main battery as a power supply and for receiving electric power from the power supply;
an auxiliary battery;
second means for using the auxiliary battery as at least part of the power supply;
third means for deciding whether or not the detected vehicle speed exceeds a predetermined reference speed;
fourth means for deciding whether or not a time elapsed since a moment at which the vehicle accessory changes from its off state to its on state reaches a predetermined reference time;
fifth means for deciding whether or not a time elapsed since a moment at which the vehicle engine ignition changes from its off state to its on state reaches a preset reference time; and
sixth means for permitting the second means to use the auxiliary battery as at least part of the power supply in at least one of 1) a first case where the third means decides that the detected vehicle speed exceeds the predetermined reference speed, 2) a second case where the fourth means decides that the elapsed time reaches the predetermined reference time, and 3) a third case where the fifth means decides that the elapsed time reaches the preset reference time.

15. An emergency reporting network system comprising:
an emergency report receiving center;
a communication network; and
emergency reporting apparatuses connectable with the emergency report receiving center via the communication network;
wherein each of the emergency reporting apparatuses comprises the emergency reporting apparatus of one of claims 11-14.

16. An emergency reporting apparatus comprising:
first means for using a main battery as a power supply and for receiving electric power from the power supply;
an auxiliary battery;
second means for deciding whether or not a voltage of the electric power from the power supply drops below a predetermined reference level;
third means for using the auxiliary battery as at least part of the power supply when the second means decides that the voltage of the electric power from the power supply drops below the predetermined reference level;
fourth means for measuring a length of a time during which the third means continues to use the auxiliary battery as at least part of the power supply, and for generating a first signal representing the measured time length;
fifth means for measuring a number of times the third means uses the auxiliary battery as at least part of the power supply, and for generating a second signal representing the measured number of times; and
sixth means for storing the first signal generated by the fourth means and the second signal generated by the fifth means.

17. An emergency reporting apparatus as recited in claim 16, further comprising seventh means for calculating a sum of time lengths measured by the fourth means, and for generating a third signal representing the calculated sum, and eighth means for storing the third signal generated by the seventh means.

18. An emergency reporting apparatus as recited in claim 17, further comprising seventh means for initializing the first signal, the second signal, and the third signal when the auxiliary battery is replaced by a new one.

19. An emergency reporting apparatus as recited in claim 16, wherein the sixth means comprises a nonvolatile memory.

20. An emergency reporting apparatus as recited in claim 17, further comprising seventh means for informing a user of contents of the first signal, the second signal, and the third signal.

21. An emergency reporting apparatus as recited in claim 17, further comprising seventh means for outputting the first signal, the second signal, and the third signal to an external device.

22. An emergency reporting apparatus as recited in claim 16, further comprising seventh means for deciding whether or not the time length measured by the fourth means exceeds a predetermined reference length, eighth means for informing when the seventh means decides that the time length measured by the fourth means exceeds the predetermined reference length, ninth means for deciding whether or not the number of times which is measured by the fifth means exceeds a predetermined reference number of times, and tenth means for informing when the ninth means decides that the number of times which is measured by the fifth means exceeds the predetermined reference number of times.

23. An emergency reporting network system comprising:
an emergency report receiving center;
a communication network; and
emergency reporting apparatuses connectable with the emergency report receiving center via the communication network;
wherein each of the emergency reporting apparatuses comprises the emergency reporting apparatus of one of claims 16-22.
